(19) United States
(12) Patent Application Publication
(10) Pub. No.: US 2024/0294300 A1
(43) Pub. Date: Sep. 5, 2024

(54) FOLDABLE BOX

(71) Applicant: Il Hoon ROH, Gyeonggi-do (KR)

(72) Inventor: Il Hoon ROH, Gyeonggi-do (KR)

(21) Appl. No.: 18/572,765

(22) PCT Filed: Jul. 21, 2022
(86) PCT No.: PCT/KR2022/010704

§ 371 Date: Dec. 20, 2023

(30) Foreign Application Priority Data
Jul. 22, 2021 (KR) 10-2021-0096723

(51) Int. Cl. B65D 5/36; B65D 5/02; F25D 3/00

(52) U.S. Cl. CPC B65D 5/3628; B65D 5/0236; F25D 3/00

(57) ABSTRACT

Provided is a foldable box. The foldable box capable of being deformed in a box mode, a development mode, and a collection mode includes a bottom portion, a plurality of side face portions connected to the bottom portion, and a plurality of connection portions connecting two adjacent side face portions to each other in the box mode, wherein in the development mode, the plurality of side face portions are developed in an outward direction and located on a same plane as the bottom portion, at least one collection fold line in a diagonal direction exists on each face of first and third side face portions facing each other of the plurality of side face portions, and the foldable box is deformed from the box mode to the collection mode by folding the first and third side face portions along the collection fold line in an inward direction of the foldable box to be folded over the bottom portion.

### TECHNICAL FIELD

The disclosure relates to a foldable box, and more particularly, to a reusable foldable box.

### BACKGROUND ART

The demand for boxes is rapidly increasing due to an increase in the online delivery market, but paper boxes and vinyl boxes, which are mainly used in the delivery market, are disposable and are not collected separately and reused. Although boxes having warming or refrigeration functions used for the delivery of some fresh foods can be collected and reused, the collection of these boxes is inconvenient due to their sizes and cleaning the inside of such boxes is also difficult.

### DISCLOSURE

### Technical Problem

The technical objective to be achieved by an embodiment of the present disclosure is directed to providing a reusable foldable box that is easily foldable and unfoldable.

### Technical Solution

To achieve the technical objective, an example of a foldable box according to an embodiment of the present disclosure includes a foldable box capable of being deformed in a box mode, a development mode, and a collection mode includes a bottom portion, a plurality of side face portions connected to the bottom portion, and a plurality of connection portions connecting two adjacent side face portions to each other in the box mode, wherein in the development mode, the plurality of side face portions are developed in an outward direction and located on a same plane as the bottom portion, at least one collection fold line in a diagonal direction exists on each face of first and third side face portions facing each other of the plurality of side face portions, and the foldable box is deformed from the box mode to the collection mode by folding the first and third side face portions along the collection fold line in an inward direction of the foldable box to be folded over the bottom portion.

### Advantageous Effects

According to an embodiment of the present disclosure, the volume of a box can be reduced by simply folding the box by pressing the side faces of the box, thereby making it convenient for the collection or storage for reuse of the box. A box can be quickly made by raising the side faces of a folded box. Furthermore, a box can be developed on the same plane for easy cleaning.

### DESCRIPTION OF DRAWINGS

FIGS. 1 to 5 are views showing an example of a foldable box according to a first embodiment of the present disclosure.

FIGS. 6 to 8 are views showing an example of a foldable box according to a second embodiment of the present disclosure.

FIGS. 9 to 11 are views showing an example of a foldable box according to a third embodiment of the present disclosure.

FIGS. 12 to 14 are views showing an example of a foldable box according to a fourth embodiment of the present disclosure.

FIGS. 15 to 17 are views showing an example of a foldable box according to a fifth embodiment of the present disclosure.

FIGS. 18 to 20 are views showing an example of a foldable box according to a sixth embodiment of the present disclosure.

FIGS. 21 to 23 are views showing an example of a foldable box according to a seventh embodiment of the present disclosure.

FIG. 24 is a view showing an example of a method of operating a cover portion, according to an embodiment of the present disclosure.

FIGS. 25 and 26 are views showing a first modified example of a cover portion according to an embodiment of the present disclosure.

FIGS. 27 and 28 are views showing a second modified example of the cover portion according to an embodiment of the present disclosure.

FIG. 29 is a view showing an example of a cold storage insert according to an embodiment of the present disclosure.

FIG. 30 is a view showing an example of a combination of a foldable box and a cold storage insert, according to an embodiment of the present disclosure.

FIGS. 31 to 34 are views showing various modified examples of the cold storage insert according to an embodiment of the present disclosure.

FIGS. 35 to 37 are views showing an example of a foldable box according to an eighth embodiment of the present disclosure.

FIGS. 38 to 40 are views showing an example of a foldable box according to a ninth embodiment of the present disclosure.

FIGS. 41 and 42 are views showing an example of a foldable box according to a tenth embodiment of the present disclosure.

### MODE FOR INVENTION

A foldable box according to an embodiment of the present disclosure may be implemented by using various materials, such as paper, vinyl, plastic, Danpla, tarpaulin, an insulating material, waterproofing cloth, and the like, or a combination of these materials, but is not limited to a particular material. When a foldable box is cleaned and reused, the foldable box may be implemented by using a waterproof material. The foldable box is deformable to a development mode, a box mode, and a collection mode. The development mode means a state in which all side faces of a box are unfolded on the same plane, the box mode means a state in which the box is folded, and the collection mode means a state in which the side faces are folded to overlap each other inside a box to reduce the volume of the box.

The foldable box according to an embodiment of the present disclosure is described below in detail with reference to the accompanying drawings.

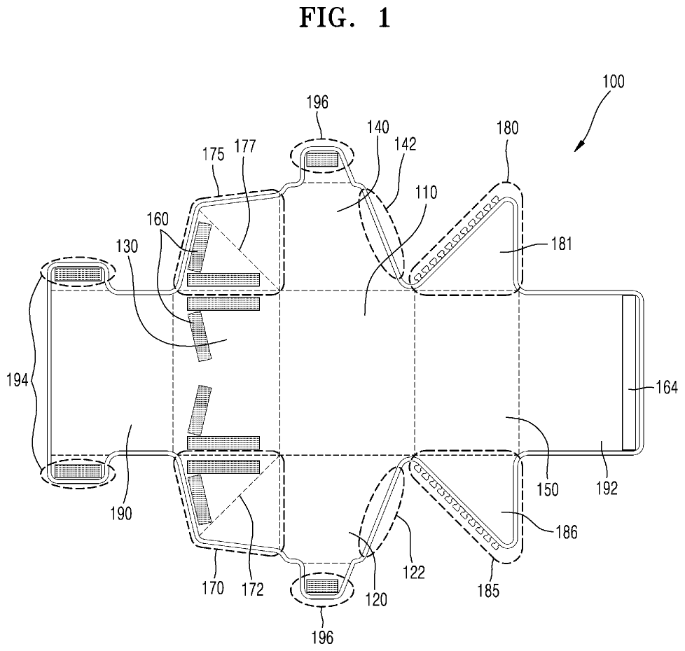

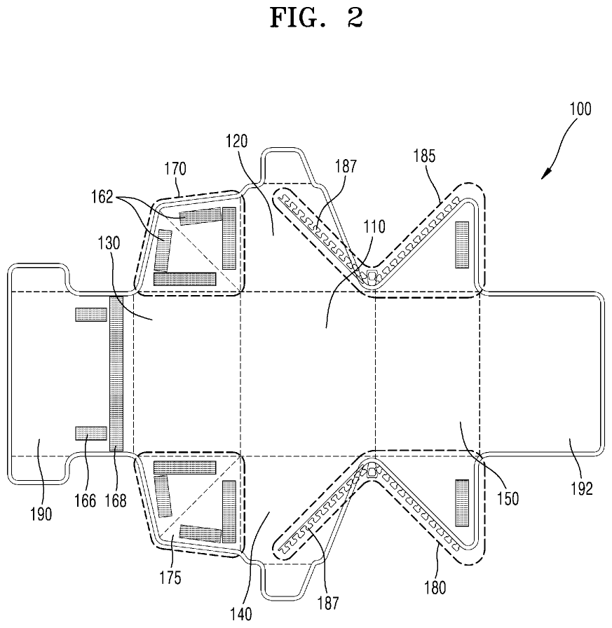

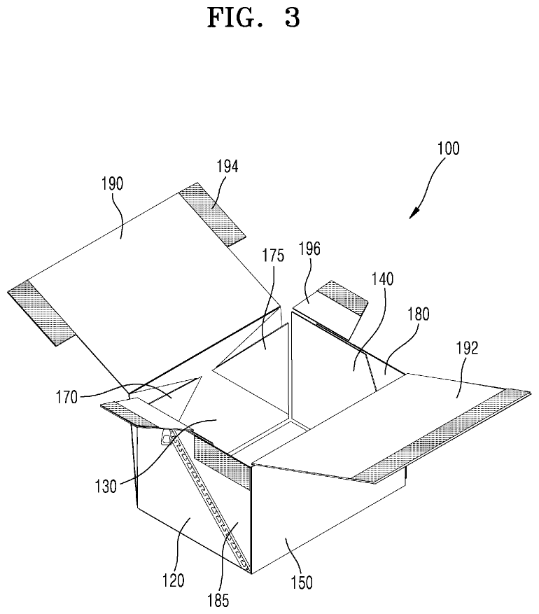

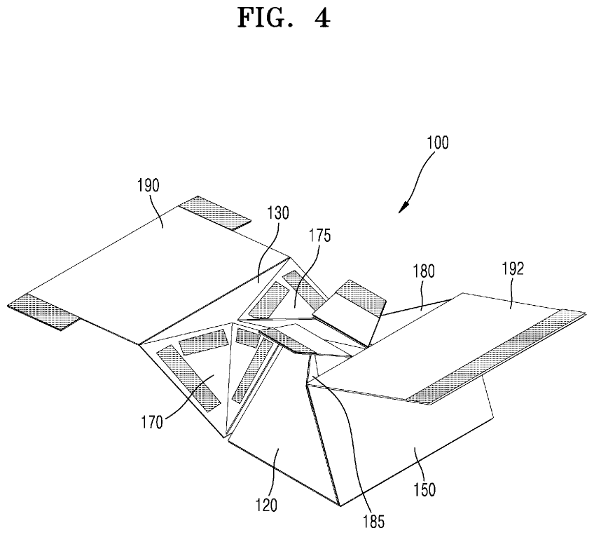

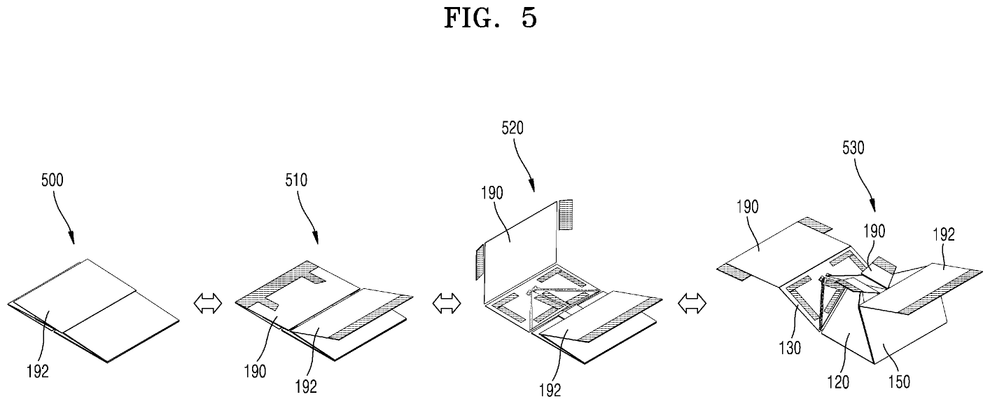

FIGS. 1 to 5 are views showing an example of a foldable box according to a first embodiment of the present disclosure. In detail, FIGS. 1 and 2 are views showing a foldable box in a development mode, FIG. 3 is a view showing the foldable box in a box mode, and FIGS. 4 and 5 are views showing a deformation process between the box mode and the collection mode.

First, referring to FIG. 1 showing the inside of a foldable box 100 in the development mode and FIG. 2 showing the outside of the foldable box 100 in the development mode, the foldable box 100 may include a bottom portion 110, a plurality of side face portions 120, 130, 140, and 150 connected to the bottom portion 110, and a plurality of connection portions 170, 175, 180, and 185 connecting two adjacent side face portions.

Although the present embodiment shows an example of including cover portions 190, 192, 194, and 196, the cover portions 190, 192, 194, and 196 may be omitted. Alternatively, the cover portions 190, 192, 194, and 196 may be in the form of being separated from the foldable box 100. Accordingly, the present disclosure may include various embodiments of a foldable box with the cover portions 190, 192, 194, and 196 omitted. However, various following embodiments including the present embodiment is described, for convenience of explanation, based on an assumption that a foldable box includes the cover portions 190, 192, 194, and 196.

The bottom portion 110 has a polygonal shape such as a quadrangle and the like forming a bottom surface of a box, and the first to fourth side face portions 120, 130, 140, and 150 are faces formed by extending a certain length from each edge of the bottom portion 110, forming the side faces of a box. In an embodiment, the first to fourth side face portions 120, 130, 140, and 150 may all have a quadrangle shape. In another embodiment, in the deformation from the box mode to the collection mode (see FIG. 4), lateral edge areas 122 and 142 of the first and third side face portions 120 and 140 may be cut in a diagonal direction so that the edge areas of the first and third side face portions 120 and 140 do not interfere with the fourth side face portion 150 when the fourth side face portion 150 is folded. In other words, the first and third side face portions 120 and 140 may each be implemented in a trapezoidal shape by cutting off some edge areas as shown in the present embodiment. In this state, when the first and third side face portions 120 and 140 each having a trapezoidal shape are folded to form a box, as parts of the side faces are opened, the open portions may be closed through connection portions 180 and 185 respectively including joint portions 181 and 186 extending from the side faces of the fourth side face portion 150 and described later.

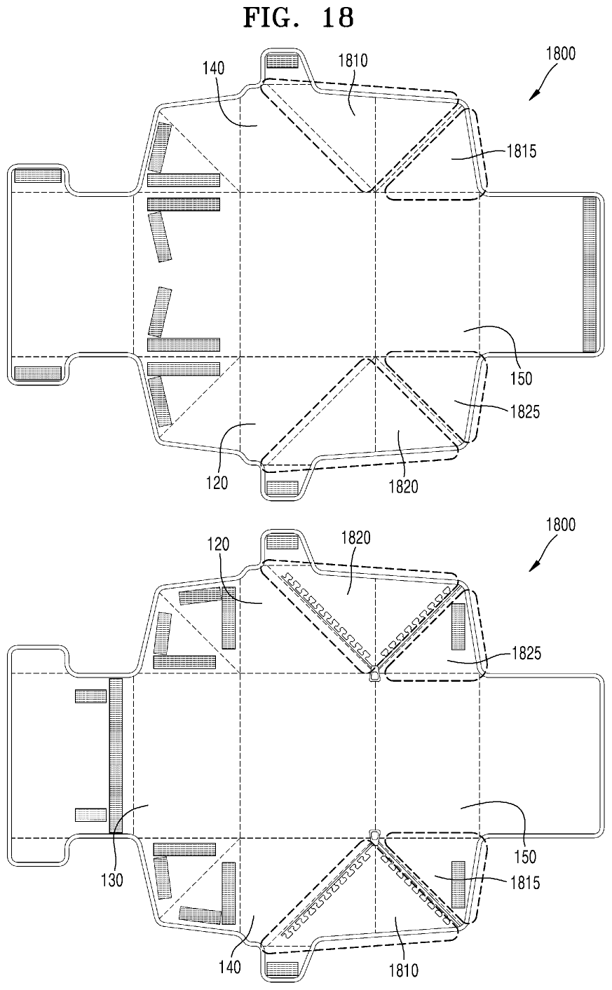

In the development mode, the bottom portion 110 and the side face portions 120, 130, 140, and 150 are located on the same plane. Although the present embodiment shows an example in which, in the development mode, an area between some side face portions (between the first side face portion 120 and the fourth side face portion 150 and between the third side face portion 140 and the fourth side face portion 150) is cut off so that an empty space exists, as illustrated in FIG. 18, a connection portion may be implemented so as to be developed in the form of a quadrangle in which no empty space exists between the bottom portion and the side face portion. In addition, the shape when the bottom portion 110, the side face portions 120, 130, 140, and 150, the connection portions 170, 175, 180, and 185, and the like are all developed on the same plane may be deformed in various shapes. As, in the development mode, the bottom portion 110, the side face portions 120, 130, 140, and 150, and the like are all developed on the same plane, the foldable box 100 may be easily cleaned, repaired. For example, automatic cleaning is possible by inputting the foldable box 100 that is unfolded on the same plane, into an automatic cleaning machine.

For the development mode, the edges between the side face portions 120, 130, 140, and 150 may be formed not in a fixed state, but in a separable state. For example, the edge between two adjacent side face portions may be in the form of being in a cut or unfoldable state. For the box mode, the connection portions 170, 175, 180, and 185 for connecting the two adjacent side face portions to each other are necessary.

The connection portions 170, 175, 180, and 185 fix the connection between the two adjacent side face portions when the foldable box 100 is folded in the box mode. Although, in the present embodiment, the connection portions 170, 175, 180, and 185 are all included between the side face portions 120, 130, 140, and 150, even when the box mode may be maintained by other structure such as the cover portions 190, 192, 194, and 196 and the like, at least one connection portion may be omitted according to an embodiment. For example, among the first to fourth connection portions 170, 175, 180, and 185, the first connection portion 170 or the third connection portion 180 and the like may be omitted. However, an embodiment below including the present embodiment is described based on an assumption that the connection portions 170, 175, 180, and 185 are all presented between the side face portions 120, 130, 140, and 150 is described.

An embodiment of the connection portion may be implemented in a first connection structure including edge areas 170 and 175 connected to the edge between the two adjacent side face portions and, when folded into a box, folded in a wing shape to face each other in an inward direction or an outward direction of the foldable box 100. The present embodiment shows an example in which the first connection structure of the edge areas 170 and 175 exists between the first and third side face portions 120 and 140 adjacent to the second side face portion 130. The edge areas 170 and 175 of the first connection structure are areas developed on the same plane with the bottom portion 110 and the side face portions 120, 130, 140, and 150 in the development mode. Although the present embodiment shows an example of a quadrangle shape, the shape may be changed variously, for example, a triangular shape and the like, according to an embodiment. Furthermore, the outlines of the edge areas 170 and 175 may be implemented in various shapes such as curves and the like. The edge areas 170 and 175 may further include box fold lines 172 and 177 of diagonal lines to facilitate folding so as to face each other when folded into a box. FIG. 3 shows an example in which the edge areas 170 and 175 are folded in an inward direction of the foldable box.

A fastening device 162 may exist in each of two areas folded to face each other so that the two areas folded to face each other are well closely folded in the edge areas 170 and 175 when folded into a box. For example, various fastening devices 162, such as Velcro, a snap button, a magnet, a zipper, and the like, capable of allowing the two faces to be in close contact with each other when folded into a box may exited in the two areas facing each other of the edge areas 170 and 175. In another embodiment, a fastening device 160 (Velcro, a snap button, a magnet, a zipper, etc.) may exist in each of one side face of the wing shape and another side face of the side face portion facing the one side face so that the edge areas 170 and 175 folded in a wing shape in an inward or outward direction of the foldable box 100 are in close contact with the second side face portion 130. In another embodiment, the whole or part of the fastening devices 160 and 162 for close contact of the edge areas 170 and 175 may be omitted.

In another embodiment of the connection portion, the connection portion may be implemented in a connection structure of various fastening devices connecting two adjacent side face portions in a cut state. The present embodiment shows second connection structures 180 and 185 including zippers between the first and third side face portions 120 and 140 adjacent to the fourth side face portion 150. A first line of a zipper is located diagonally in each of the first and third side face portions 120 and 140, and a second line of the zipper is located diagonally at an edge of each of the joint portions 181 and 186 extending from the sides of the fourth side face portion 150. Although the present embodiment shows an example in which the first line of the zipper is located in a face that is not the edge of each of the first and third side face portions 120 and 140, in another example, the first line of the zipper may be located at the edge of each of the first and third side face portions 120 and 140. The shapes of the joint portions 181 and 186 extending from the sides of the fourth side face portion 150 is deformable in various shapes other than a triangular shape.

When folded in the box mode, as illustrated in FIG. 3, the zippers of the second connection structures 180 and 185 are coupled to each other such that the first line and the second line are engaged with each other, thereby fixing the connection between the fourth side face portion 150 and the first and third side face portions 120 and 140. The fastening devices of the second connection structures 180 and 185 may be implemented by various members, such as Velcro, a magnet, a snap button, and the like, in addition to the zipper of the present embodiment.

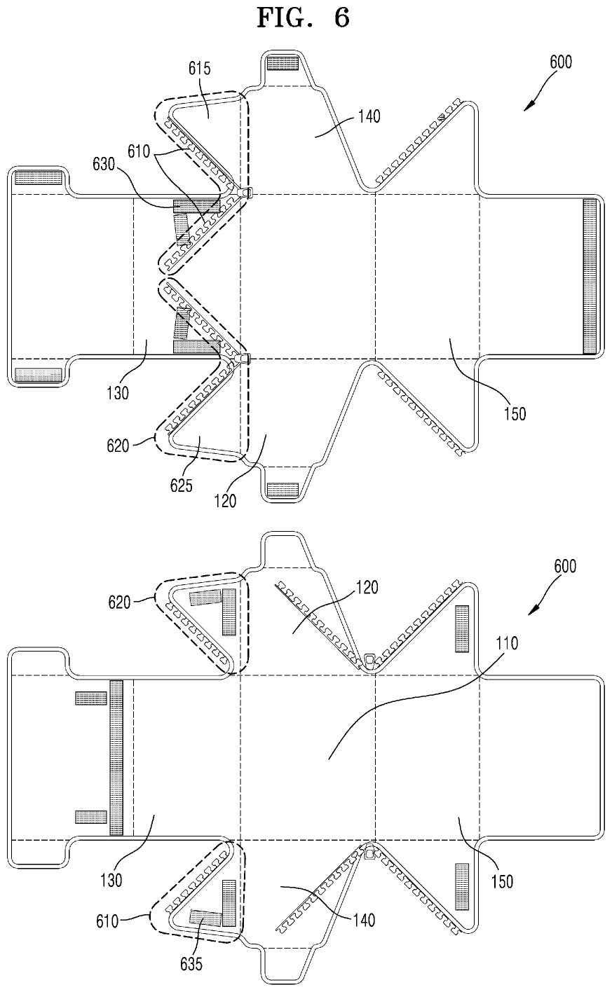

Although the present embodiment shows an example of the foldable box 100 including the first connection structures 170 and 175 and the second connection structures 180 and 185 together, in another embodiment, the connection portions 170, 175, 180, and 185 may be all configured with the first connection structure of the edge areas 170 and 175 or the second connection structures 180 and 185, such as zippers and the like. In another embodiment, a method of connecting two adjacent side face portions to each other may be variously changed as illustrated in FIGS. 6 to 23, and the present embodiment is not necessarily limited thereto.

Referring to FIG. 3, the foldable box 100 in the development mode may be folded and converted into the box mode. A box shape may be made by connecting the two adjacent side face portions to each other by using the connection portions 170, 175, 180, and 185. For example, the foldable box 100 may be deformed from the development mode to the box mode by folding the edge areas 170 and 175 that form the first connection structure between the second side face portion 130 and the first and third side face portions 120 and 140 inwardly into the foldable box 100, and by closing the zippers that are the second connection structures 180 and 185 between the fourth side face portion 150 and the first and third side face portions 120 and 140. Reversely, by releasing all connections of the connection portions between the two adjacent side face portions, the foldable box 100 may be deformed from the box mode to the development mode as illustrated in FIG. 1.

A collection fold line 187 to fold the side face portion inwardly into the foldable box 100 exists in the side face portions 120 and 140 of the foldable box 100. The collection fold line 187 may be formed in a straight line in a diagonal direction inclined at a certain angle to connect to the vertex of the bottom portion 110, to make the fourth side face portion 150 folded together inwardly into the foldable box 100 when folding the first and third side face portions 120 and 140 inwardly into the foldable box 100 as illustrated in FIG. 4. The collection fold line 187 is a guideline to allow the two areas 140 and 181 or 120 and 186 of the side face divided with respect to the collection fold line 187 to be folded facing each other when a force is applied from the side faces of the foldable box 100, and may be formed through various structures. An angle (e.g., 45°, etc.) at which the first and third side face portions 120 and 140 and the fourth side face portion 150 are foldable to overlap each other is sufficient as the angle of the diagonal direction of the collection fold line 187, and thus, the angle may be variously changed according to an embodiment.

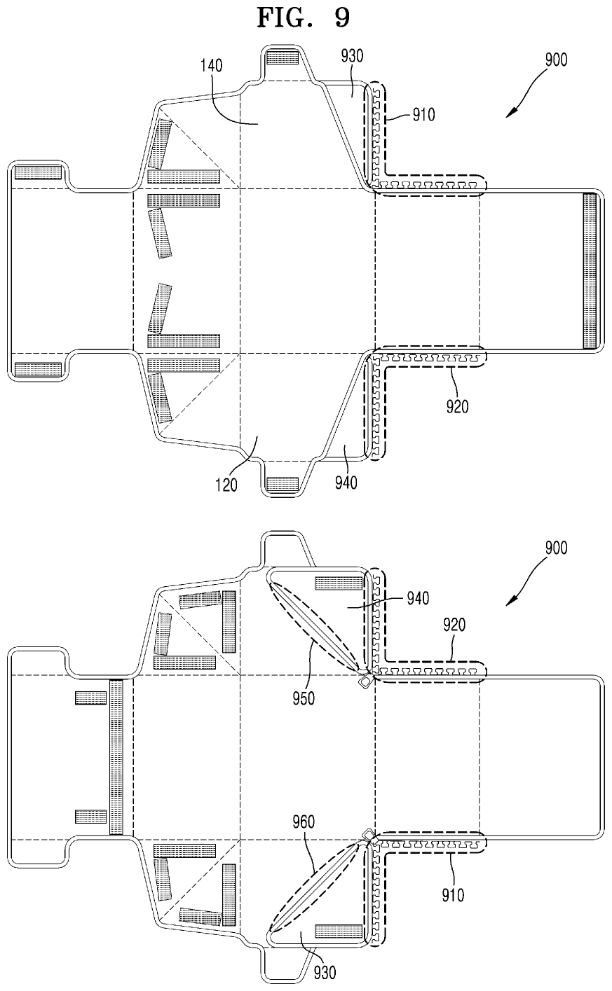

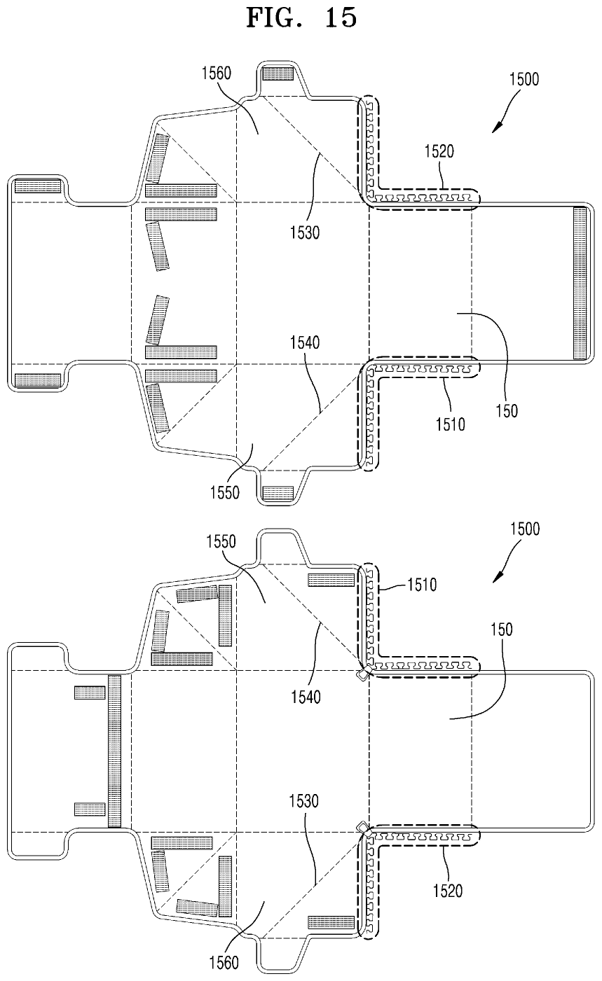

The collection fold line 187 may be a virtually formed line by various structures or a line explicitly formed on the surface for folding. For example, as in the present embodiment, the first line of the zipper of each of the second connection structures 180 and 185 may be used as the collection fold line 187, or as illustrated in FIG. 15, fold lines pressed and engraved to a certain depth for folding may be used as collection fold lines 1530 and 1540. Alternatively, as illustrated in FIG. 9, edges 950 and 960 in a diagonal direction of added portions 930 and 940 that are added on the side faces to allow the side face portions of a foldable box to be folded in the diagonal direction may be used as collection fold lines.

When a force is applied to the first and third side face portions 120 and 140 inwardly from the outside of the foldable box 100, as illustrated in FIG. 4, two areas of each side face of the first and third side face portions 120 and 140 are folded along the collection fold line 187 to face each other, and accordingly, the fourth side face portion 150 is folded inwardly into the foldable box 100 together with the first and third side face portions 120 and 140. In an embodiment, when the first and third side face portions 120 and 140 are folded along the collection fold line 187 in an inward direction of the foldable box 100, the heights of the first and third side face portions 120 and 140 may be determined to prevent the two side face portions 120 and 140 from overlapping each other. For example, the height of each of the first and third side face portions 120 and 140 may be ½ or less of the length of the bottom portion 110 between the first and third side face portions 120 and 140. In another embodiment, when the first and third side face portions 120 and 140 are folded along the collection fold line 187 in the inward direction of the foldable box, the heights of the first and third side face portions 120 and 140 may be determined to allow the two side face portions 120 and 140 to partially overlap each other. For example, the height of each of the first and third side face portions 120 and 140 may be ½ or more of the length of the bottom portion 110 between the first and third side face portions 120 and 140.

Although various following embodiments including the present embodiment shows an example of including one collection fold line in each of the first and third side face portions 120 and 140, in another embodiment, two collection fold lines may exist in each of the first and third side face portions 120 and 140. For example, two collection fold lines each formed in a diagonal direction from two vertexes contacting the bottom portion 110 may exist in each of the first and third side face portions 120 and 140. In this case, when the first and third side face portions 120 and 140 are folded inwardly, the second and fourth side face portions 130 and 150 may be folded together inwardly into the foldable box 100 to be overlapped with the bottom portion 110. In this case, the width of the side face portion needs to be increased such that two collection fold lines exist.

When the foldable box 100 is deformed from the box mode to the collection mode along the collection fold line 187, a connection of the connection portion between the two adjacent side face portions is not released and is maintained. For example, while the connection of the second connection structures 180 and 185 between the fourth side face portion 150 and the first and third side face portions 120 and 140 adjacent thereto remains (i.e., a state of the zippers being closed), the foldable box 100 is deformed to the collection mode. Accordingly, the deformation from the box mode to the collection mode may be quickly performed.

Referring to FIG. 5, a deformation process between the box mode and the collection mode is illustrated. In the box mode, when the second side face portion 130 is unfolded in an outward direction of the foldable box, the fastening devices 162 of the two areas facing each other of the edge areas 170 and 175 between the first and third side face portions 120 and 140 and the second side face portion 130 are separated from each other and unfolded. In this state, when the first and third side face portions 120 and 140 are folded in the inward direction along the collection fold line 187 (530), the fourth side face portion 150 is folded in an inward direction of the foldable box together with the first and third side face portions 120 and 140, and overlapped with the bottom portion 110 (520). In other words, the bottom portion 110 and the second side face portion 130 are unformed on the same plane, and the first and third side face portions 120 and 140 and the fourth side face portion 150 are folded to overlap one another on the bottom portion 110. When the cover portions 190 and 192 exist, the cover portions 190 and 192 may be folded to overlap each other on the bottom portion 110 or the second side face portion 130 (500 and 510). Although the present embodiment describes the folding of the respective side face portions in a restricted order to help understanding, this is merely an example, and the order of folding the respective side face portions may be changed in various ways.

In the case of the present embodiment, without unfolding the foldable box 100 in the development mode and then folding again, in the box mode, the first and third side face portions 120 and 140 may be folded inwardly into the foldable box to be deformed to the collection mode, and thus, the deformation to the collection mode is possible even in a narrow space. Furthermore, in the collection mode, the foldable box 100 is deformed in a thin quadrangle shape having the size of the bottom portion 110 and the second side face portion 130, and thus, it is convenient for storage, transfer, collection, and the like.

Reversely, in the foldable box folded in the collection mode, by raising the second cover portion 192 (when there is no cover portion, the fourth side face portion 150), the fourth side face portion 150 and the first and third side face portions 120 and 140 adjacent thereto are erected together. As the connection between each of the first and third side face portions 120 and 140 and the fourth side face portion 150 maintains a fixed state when the foldable box 100 is deformed from the box mode to the collection mode, by raising the fourth side face portion 150, the fourth side face portion 150 and the first and third side face portions 120 and 140 adjacent thereto are erected together. When the second side face portion 130 is erected and fixed, the foldable box 100 is in the box mode. In other words, in the collection mode (500), without manually raising the first and third side face portions 120 and 140, by holding with both hands and raising the cover portions 190 and 192 (or the second and fourth side face portions 130 and 150), the foldable box 100 may be easily deformed in the box mode.

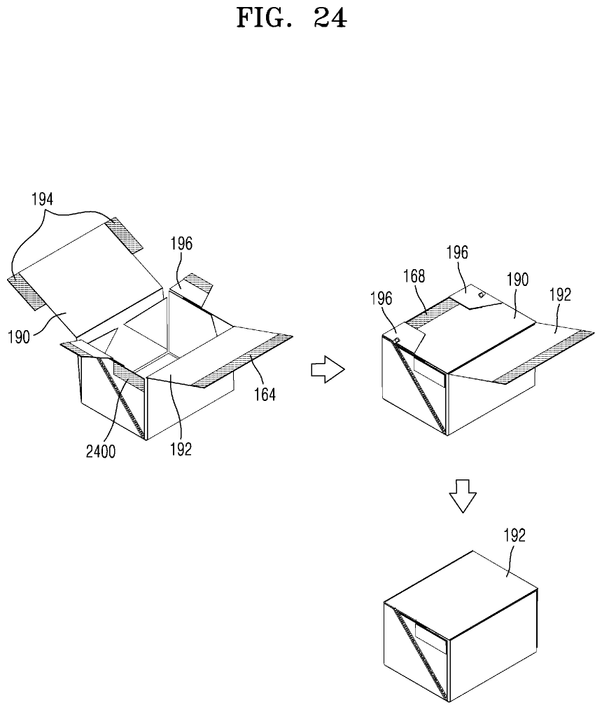

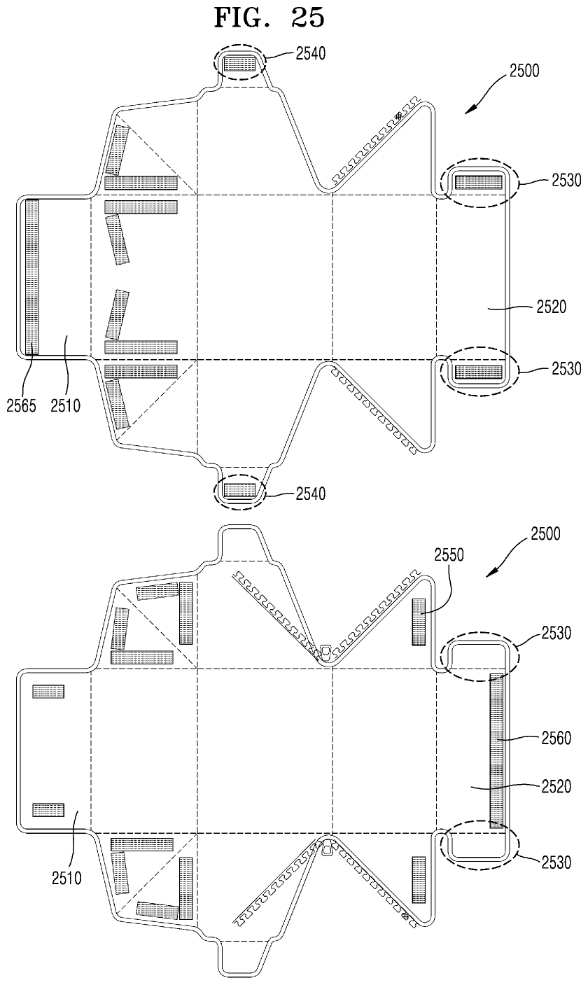

The cover portions may include the first cover portion 190 extending from the second side face portion 130, the second cover portion 192 extending from the fourth side face portion 150, and a first flap portion 194 and a second flap portion 196 each having a wing shape. Although, in the present embodiment, the first cover portion 190 and the second cover portion 192 are each implemented as having a size enough to cover the whole of a top surface of the foldable box 100, in another embodiment, as illustrated in FIG. 25, the first cover portion 190 and the second cover portion 192 may each be implemented as having a size enough to cover a part of the top surface thereof. A method of fixing the cover portions to the top surface of the foldable box 100 by using the first flap portion 194 and the second flap portion 196 will be described again with reference to FIG. 24. The cover portions of the present embodiment is merely an example, and the present disclosure is not limited thereto. Cover portions having various shapes according to the related art may be applied to the present embodiment, and furthermore, the cover portions may be omitted.

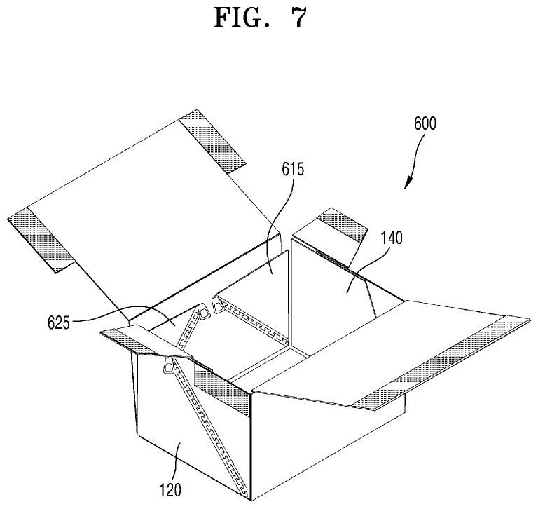

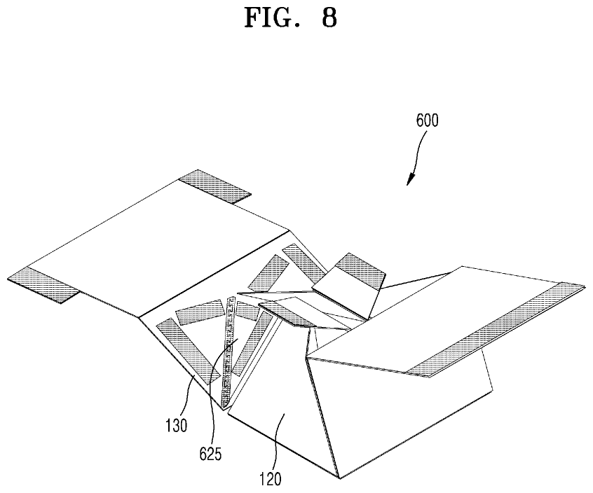

FIGS. 6 to 8 are views showing an example of a foldable box according to a second embodiment of the present disclosure. FIG. 6 illustrates an inner surface (upper diagram) and an outer surface (lower diagram) of a foldable box in the development mode, FIG. 7 illustrates the foldable box in the box mode, and FIG. 8 illustrates a process of deforming the foldable box in the collection mode.

Referring to FIGS. 6 to 8 together, a foldable box 600 according to a second embodiment, compared with the foldable box 100 of the first embodiment, has a different configuration in the connection portion between the second side face portion 130 and the first and third side face portions 120 and 140, while other configurations are identical. The different configurations are mainly described below.

A portion between the second side face portion 130 and the first and third side face portions 120 and 140 is cut. The portions between the second side face portion 130 and the first and third side face portions 120 and 140 are provided with third connection structures 610 and 620 including zippers. The first lines of the zippers are located in diagonal directions in an inner surface of the second side face portion 130, and the second lines of the zippers are located in diagonal directions on joint portions 615 and 625 extending from the sides of the first and third side face portions 120 and 140.

In the development mode, the angle in a diagonal direction between the first line and the second line of the of the zipper is an angle at which, when the zippers are closed, the second side face portion 130 and the first and third side face portions 120 and 140 are erected at a right angle. For example, in the development mode, the first line and the second line of the zipper may be implemented to be 90°.

By closing all zippers of a plurality of connection portions, the foldable box 600 may be deformed from the development mode to the box mode. In the box mode, when the zippers are closed, the joint portions 615 and 625 and the second side face portion 130 face each other. In this state, fastening devices 630 and 635 (e.g., Velcro, a snap button, a magnet, etc.) may exist on two faces facing each other of the joint portions 615 and 625 and the second side face portion 130 so that the joint portions 615 and 625 may be in close contact with the second side face portion 130.

In the box mode, as in the first embodiment, the collection fold line exists in each surface of the first and third side face portions 120 and 140. Accordingly, when the foldable box 600 is deformed from the box mode to the collection mode, as illustrated in FIG. 8, the first and third side face portions 120 and 140 are folded inwardly into the foldable box 600 along the collection fold lines together with the fourth side face portion 150 to be overlapped with the bottom portion 110, the second side face portion 130 is unfolded in an outward direction of the foldable box so as to exist on the same plane with the bottom portion 110, and the joint portions 615 and 625 of the third connection structure are unfolded on the same plane with the first and third side face portions 120 and 140.

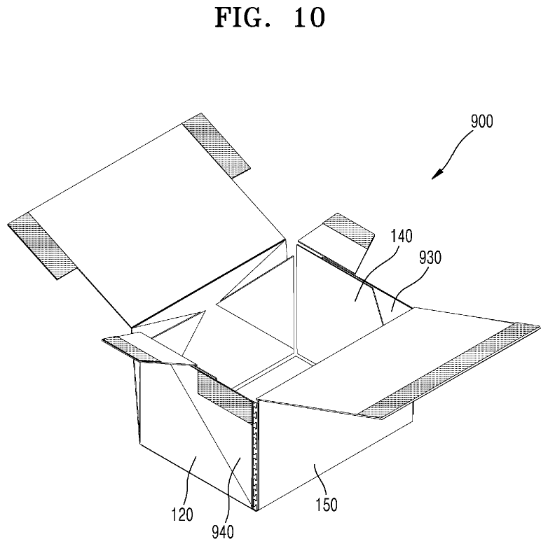

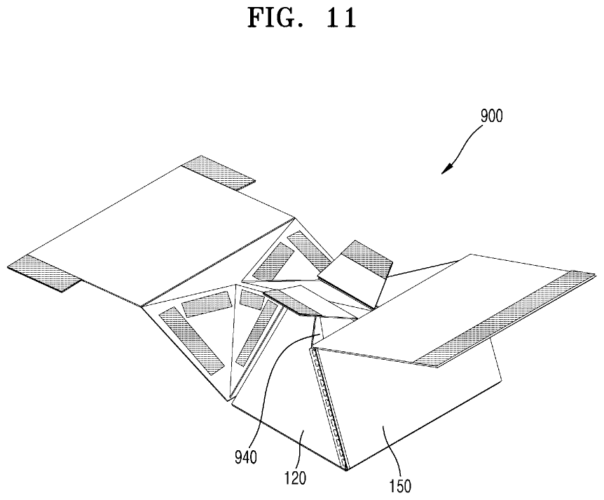

FIGS. 9 to 11 are views showing an example of a foldable box according to a third embodiment of the present disclosure. FIG. 9 illustrates an inner surface (upper diagram) and an outer surface (lower diagram) of a foldable box in the development mode, FIG. 10 illustrates the foldable box in the box mode, and FIG. 11 illustrates a process of deforming the foldable box in the collection mode.

Referring to FIGS. 9 to 11 together, a foldable box 900 according to a third embodiment, compared with the foldable box 100 of the first embodiment, has a different configuration in the connection portions between the fourth side face portion 150 and the first and third side face portions 120 and 140.

The connection portions between the fourth side face portion 150 and the first and third side face portions 120 and 140 are provided with the fourth connection structures 910 and 920 including zippers. The first lines of the zippers of the fourth connection structures 910 and 920 are located at the side edges of the fourth side face portion 150, and the second lines of the zippers are located at the respective side edges of the first and third side face portions 120 and 140. In other words, as the connection portions are implemented as zippers at the edges of two adjacent side face portions, as illustrated in FIG. 10, the edges of two adjacent side face portions may be connected to each other by closing the zippers.

The deformation from the development mode to the box mode may be made by connecting and fixing the adjacent side face portions using a plurality of connection portions. Reversely, by removing all connections of the connection portions in the box mode, the foldable box 900 may be deformed in the development mode.

To form a collection fold line for the deformation from the box mode to the collection mode, the third embodiment may include, in the first and third side face portions 120 and 140, the added portions 930 and 940 including edges in diagonal directions serving as collection fold lines. Although the present embodiment shows the added portions 930 and 940 each having a triangular shape, the added portions 930 and 940 may be deformed in various shapes including the edges 950 and 960 in diagonal directions only when the edges 950 and 960 in the diagonal directions serve as collection fold lines. Although the present embodiment shows that the first and third side face portions 120 and 140 are formed to be trapezoidal and include the added portions 930 and 940 at one side thereof, in another example, the first and third side face portions 120 and 140 may be implemented in a quadrangle shape, and the second lines of the zippers may be located at the side edges of the first and third side face portions 120 and 140.

When a force is applied to the first and third side face portions 120 and 140 inwardly from the outside, as illustrated in FIG. 11, the first and third side face portions 120 and 140 and the fourth side face portion 150 are folded inwardly into the foldable box along the edges 950 and 960 (i.e., the collection fold lines) of the added portions 930 and 940 and overlapped with the bottom portion 110.

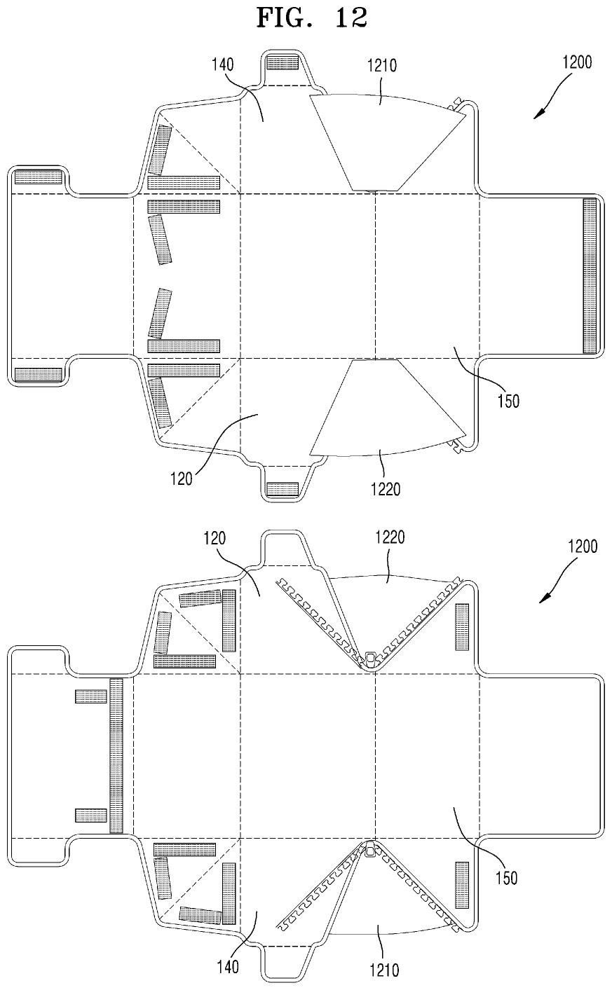

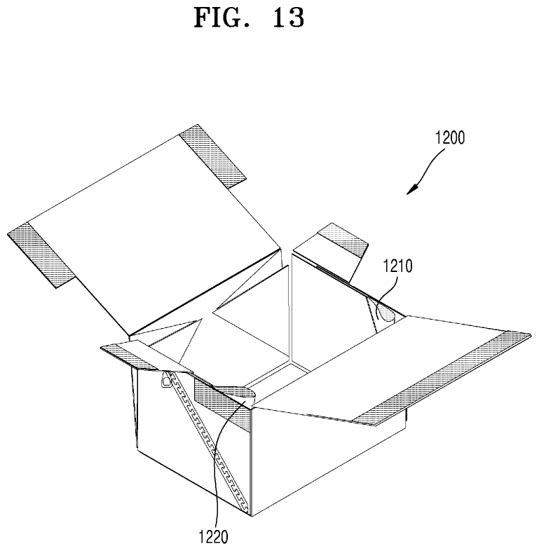

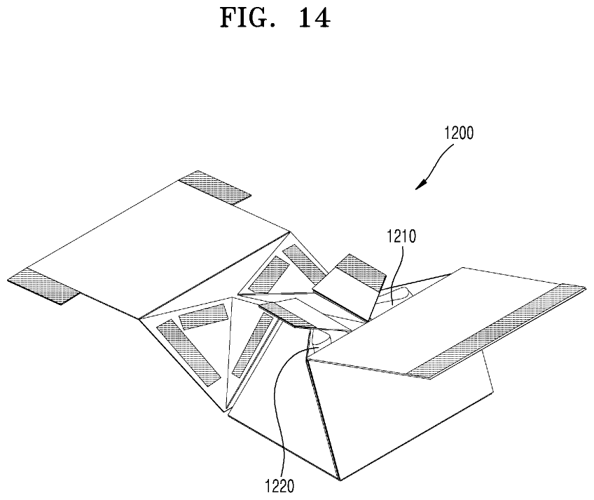

FIGS. 12 to 14 are views showing an example of a foldable box according to a fourth embodiment of the present disclosure. FIG. 12 illustrates an inner surface (upper diagram) and an outer surface (lower diagram) of a foldable box in the development mode, FIG. 13 illustrates the foldable box in the box mode, and FIG. 14 illustrates a process of deforming the foldable box in the collection mode.

Referring to FIGS. 12 to 14 together, a foldable box 1200 according to a fourth embodiment, compared with the foldable box 100 of the first embodiment, may further include screens 1210 and 1220 between the fourth side face portion 150 and the first and third side face portions 120 and 140.

The screens 1210 and 1220 exist in empty space between each of the first and third side face portions 120 and 140 and the fourth side face portion 150. Although the present embodiment shows the screens 1210 and 1220 each having a fan shape, the shapes of the screens 1210 and 1220 may be changed variously only when the empty space of the cut portion between each of the first and third side face portions 120 and 140 and the fourth side face portion 150 is blocked.

The screens 1210 and 1220 may be implemented in the form of being completely unfolded with the side face portions 120, 130, 140, and 150 and the bottom bottom portion 110, in the development mode, between the fourth side face portion 150 and the first and third side face portions 120 and 140. In the development mode, when the screens 1210 and 1220 are completely unfolded, cleaning and the like of the foldable box 1200 may be made easy. When the foldable box 1200 is folded from the development mode to the box mode, the screens 1210 and 1220 may be folded, as illustrated in FIG. 13, inwardly into the foldable box 1200. Thus, as the heat escaping from the edges may be prevented through the screens 1210 and 1220, the cooling effect of the foldable box 1200 may be increased.

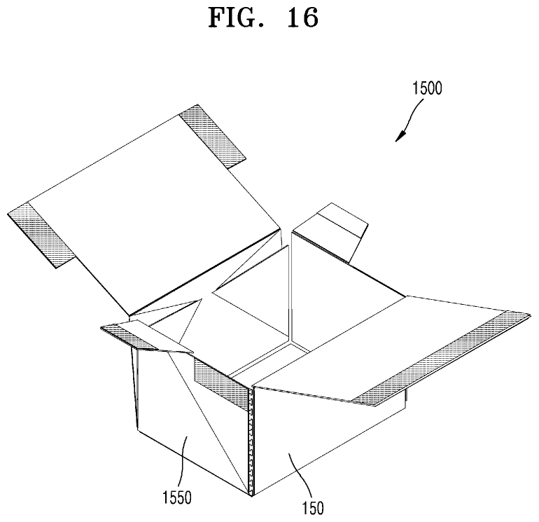

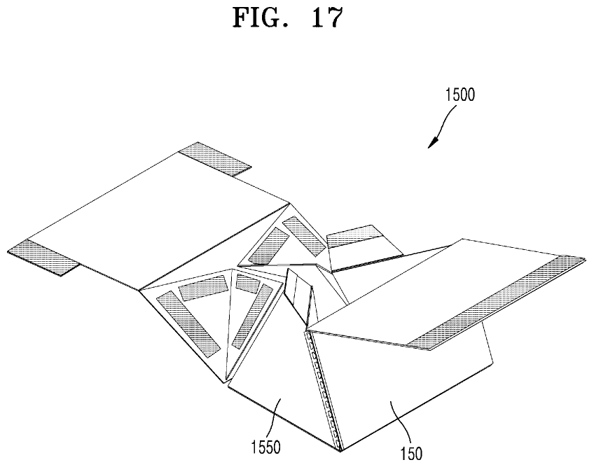

FIGS. 15 to 18 are views showing an example of a foldable box according to a fifth embodiment of the present disclosure. FIG. 15 illustrates an inner surface (upper diagram) and an outer surface (lower diagram) of a foldable box in the development mode, FIG. 16 illustrates the foldable box in the box mode, and FIG. 17 illustrates a process of deforming the foldable box in the collection mode.

Referring to FIGS. 15 to 17 together, a foldable box 1500 according to a fifth embodiment, compared with the foldable box 900 of the third embodiment (see FIGS. 9 to 11), has a different method of implementing collection fold lines 1530 and 1540.

While, in the third embodiment, the collection fold line are implemented by adding the added portions 930 and 940 including the edges 950 and 960 in the diagonal directions to the first and third side face portions 120 and 140, in the foldable box 1500 of the fifth embodiment, the collection fold lines are implemented by forming first and third side face portions 1550 and 1560 each in a quadrangle shape and fold lines 1530 and 1540 each engraved to a certain depth in each surface. Connection portions 1510 and 1520 between the fourth side face portion 150 and the first and third side face portions 1550 and 1560 may be configured with zippers located at the side edges of two adjacent side face portions. The first and third side face portions 1550 and 1560 are folded along the fold lines 1530 and 1540 (i.e., the collection fold lines) so that the foldable box 1500 is deformed from the box mode to the collection mode.

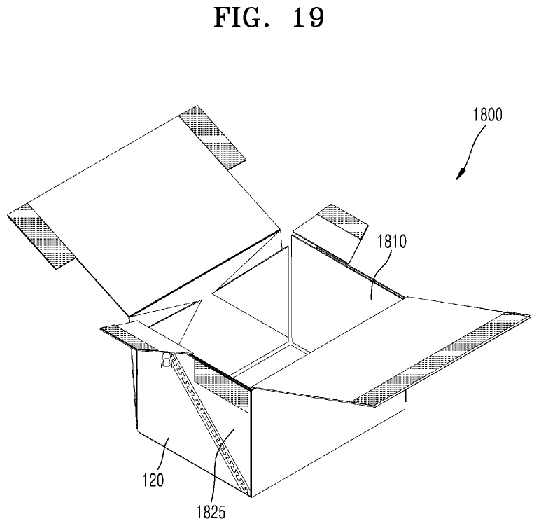

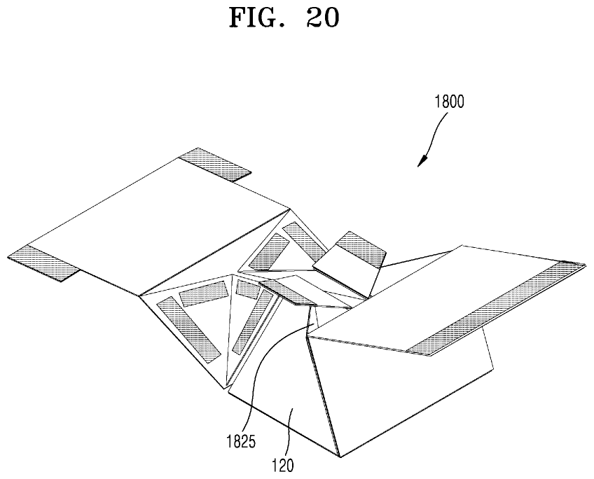

FIGS. 18 to 20 are views showing an example of a foldable box according to a sixth embodiment of the present disclosure. FIG. 18 illustrates an inner surface (upper diagram) and an outer surface (lower diagram) of a foldable box in the development mode, FIG. 19 illustrates the foldable box in the box mode, and FIG. 20 illustrates a process of deforming the foldable box in the collection mode.

Referring to FIGS. 18 to 20 together, a foldable box 1800 according to a sixth embodiment, compared with the foldable box 100 of the first embodiment, has a different configuration in the connection portions between the fourth side face portion 150 and the first and third side face portions 120 and 140.

While, in the first embodiment, in the development mode, the empty space exists as the portion between each of the first and third side face portions 120 and 140 and the fourth side face portion 150 is cut, in the sixth embodiment, empty space does not exist between each of the first and third side face portions 120 and 140 and the fourth side face portion 150.

In the present embodiment, fifth connection structures including joint portions 1815 and 1825, folded portions 1810 and 1820, and zippers exist between each of the first and third side face portions 120 and 140 and the fourth side face portion 150. In the development mode, the bottom portion 110, the side face portions 120, 130, 140, and 150, the joint portions 1815 and 1825, and the folded portions 1810 and 1820 all exist on one plane. Accordingly, the foldable box 1800 of sixth embodiment may be implemented in one quadrangle shape in the development mode.

When the foldable box 1800 is folded in the box mode, the folded portions 1810 and 1820 located between the first line and second line of the zipper constituting the fifth connection structure are folded in an inward direction of the foldable box, and the joint portions 1815 and 1825 located at the sides of the fourth side face portion 150 are connected to the first and third side face portions 120 and 140 through the zippers forming the side faces. As illustrated in FIG. 20, the first and third side face portions 120 and 140 and the fourth side face portion 150 together are folded along the collection fold lines formed of the first lines of the zippers in the inward direction of the foldable box 1800, and then, the foldable box 1800 may be deformed in the collection mode.

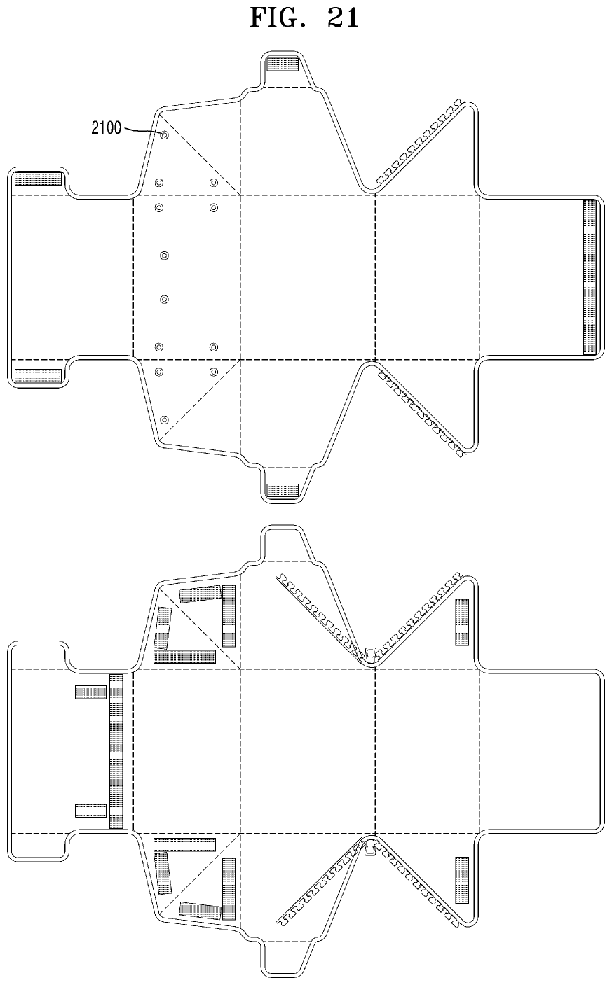

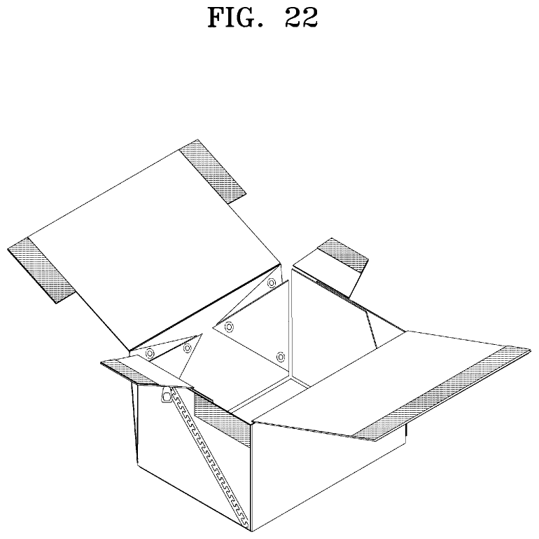

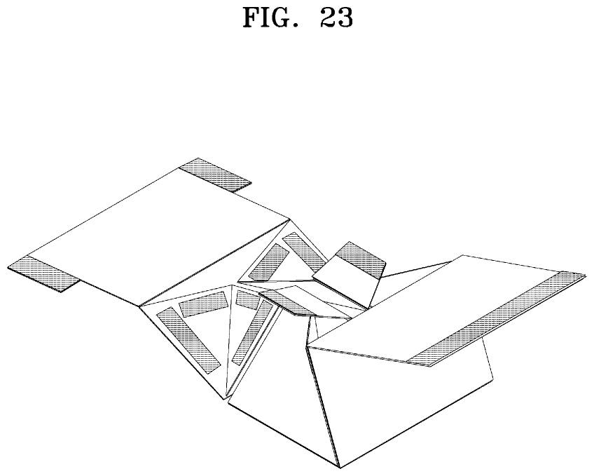

FIGS. 21 to 23 are views showing an example of a foldable box according to a seventh embodiment of the present disclosure. FIG. 21 illustrates an inner surface (upper diagram) and an outer surface (lower diagram) of a foldable box in the development mode, FIG. 22 illustrates the foldable box in the box mode, and FIG. 23 illustrates a process of deforming the foldable box in the collection mode.

Referring to FIGS. 21 to 23, a foldable box according to a seventh embodiment, compared with the foldable box 100 of the first embodiment, has a different fixing device of an edge area. The edge area that is folded inwardly into the foldable box when the foldable box is folded in the box mode may be brought into close contact with the second side face portion by using snap buttons 2100.

The foldable boxes of the first to seventh embodiments illustrated in FIGS. 1 to 23 are examples to help understanding of the present disclosure, and foldable boxes may be implemented by combining various structures described in the first to seventh embodiments by various methods. For example the four connection portions that respectively connect the four side face portions of the foldable box may all be configured with the fourth connection structure of zippers illustrated in the third embodiment (FIG. 9). Alternatively, the respective configurations of the first to seventh embodiments may be combined in various ways, for example, the configuration of the screen of the fourth embodiment (FIG. 12) is applied to the third embodiment, and the like.

FIG. 24 is a view showing an example of a method of operating a cover portion, according to an embodiment of the present disclosure.

Referring to FIG. 24, each of the foldable boxes of the first to seventh embodiments may include the first cover portion 190 and the second cover portion 192 respectively extending from the second and fourth side face portions 130 and 150. Furthermore, the foldable box may include, for example, the first flap portion 194 having a certain area and protruding in a wing shape from each of the lateral sides of the first cover portion 190. Furthermore, the foldable box may include the second flap portion 196 having a certain area and extending from each of the upper sides of the first and third side face portions 120 and 140.

A fastening device exists on one side of each of the first flap portion 194 and the second flap portion 196. Examples of the fastening device of the first flap portion 194 and the second flap portion 196 include Velcro, a snap button, a magnet, etc. In addition, various fastening devices according to the related art may be applied to the present embodiment and are not limited to any one example. The following embodiment is described, for convenience of explanation, based on an assumption that an example of the fastening device of the first flap portion 194 and the second flap portion 196 is Velcro.

When, in the box mode, the top portion of the foldable box is covered with the first cover portion 190, Velcro 2400 that may be connected to Velcro of the first flap portion 194 exists on the side face of the foldable box that meets the first flap portion 194 of the first cover portion 190. The first cover portion 190 may be fixed by attaching the first flap portion 194 to the Velcro 2400 of the side face.

The second flap portion 196 is attached to the outer surface of the first cover portion 190. While the first flap portion 194 is a configuration to connect and fix the first cover portion 190 to the side face of the foldable box, the second flap portion 196 is a configuration to connect and fix the side face of the foldable box to the first cover portion 190. As the first flap portion 194 and the second flap portion 196 fix the first cover portion 190 parallel to each other in different directions on the side face of the foldable box, the first cover portion 190 may withstand a load in a vertical direction well. Velcro 168 to be connected to the second flap portion 196 exists on the outer surface of the first cover portion 190.

The second cover portion 192 is coupled to the first cover portion 190 to overlap each other. Velcro 164 that is connected to the Velcro 168 located at one side of the outer surface of the first cover portion 190 exists is located at one side of the second cover portion 192. Furthermore, by covering with the second cover portion 192, the foldable box may not be opened easily through a security tag and the like.

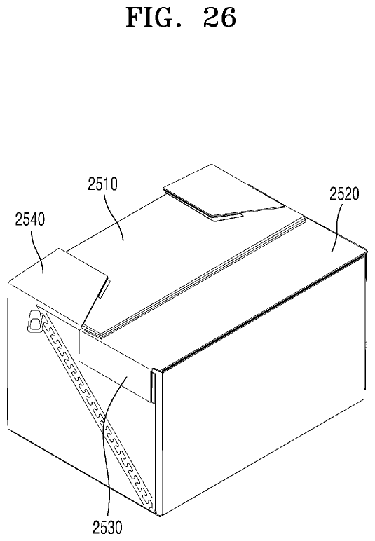

FIGS. 25 and 26 are views showing a first modified example of a cover portion according to an embodiment of the present disclosure.

Referring to FIGS. 25 and 26 together, the cover portion may include a first cover portion 2510, a second cover portion 2520, a first flap portion 2530, and a second flap portion 2540, wherein the first cover portion 2510 and the second cover portion 2520 respectively extend from the second and fourth side face portions 130 and 150. While each of the first and second cover portions 190 and 192 of the first embodiment has a size to cover the whole of the top surface, each of the first and second cover portions 2510 and 2520 of the present embodiment has a size to cover a part of the top surface. In other words, the area of the first cover portion 2510 and the area of the second cover portion 2520 may be implemented such that the sum of the areas of the two cover portions 2510 and 2520 is greater than or equal to the area of the top surface.

The first flap portion 2530 is located at the sides of the second cover portion 2520. The second flap portion 2540 is the same as the second flap portion 196 illustrated in FIG. 24. First, the first flap portion 2530 is connected to the side face of the foldable box when the top surface of the foldable box is covered with the second cover portion 2520. A fastening device 2550 (e.g., Velcro, a magnet, a snap button, etc.) connected to a fastening device (e.g., Velcro, a magnet, a snap button, etc.) of the first flap portion 2530 exists at one side of the side face of the foldable box.

After the foldable box is covered with the second cover portion 2520, the second cover portion 2520 is covered with the first cover portion 2510. Fastening devices 2560 and 2565 (e.g., Velcro, a magnet, a snap button, etc.) capable of connecting the two cover portions exist at a portion where the second cover portion 2520 and the first cover portion 2510 face each other. After covering both of the first and second cover portions 2510 and 2520, the second flap portion 2540 is connected to the outer surface of the first cover portion 2510. A fastening device (e.g., Velcro, a magnet, a snap button, etc.) exists in the area where the second flap portion 2540 meets the first cover portion 2510.

Although the present embodiment shows a modified example of the cover portion based on the foldable box 100 of the first embodiment, the cover portions of the second to seventh embodiments may also be implemented as the cover portion of the present embodiment.

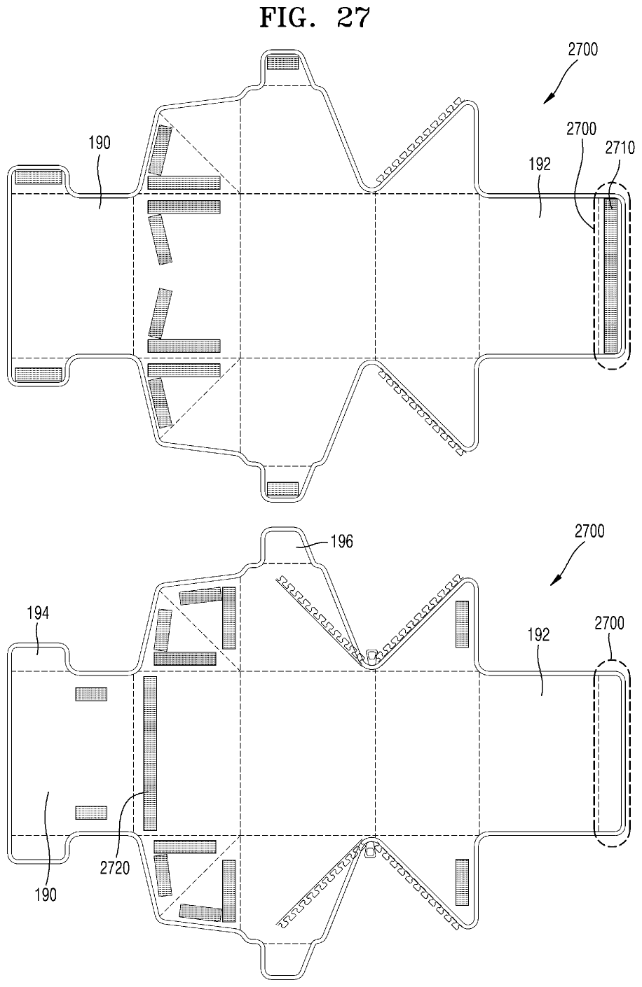

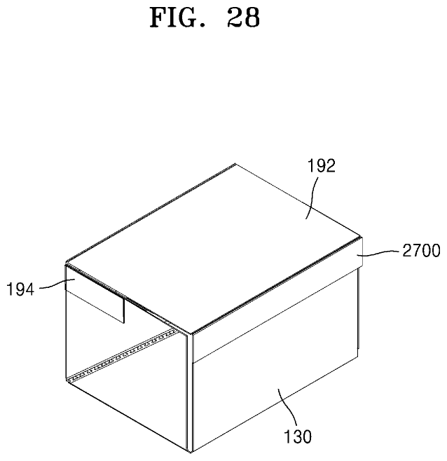

FIGS. 27 and 28 are views showing a second modified example of the cover portion according to an embodiment of the present disclosure.

Referring to FIGS. 27 and 28 together, the cover portion may include, as in the embodiment of FIG. 1, the first cover portion 190, the second cover portion 192, the first flap portion 194, and the second flap portion 196, wherein the first cover portion 190 and the second cover portion 192 respectively extend from the second and fourth side face portions 130 and 150. In addition, the cover portion of the present embodiment further includes a third flap portion 2700 extending from the upper side of the second cover portion 192. A fastening device 2710 (e.g., Velcro, a magnet, a snap button, etc.) exists in the third flap portion 2700. When the first cover portion 190 is covered with the second cover portion 192, a fastening device 2720 (e.g., Velcro, a magnet, a snap button, etc.) connected to the third flap portion 2700 exists at one side of the second side face portion 130 facing the third flap portion 2700.

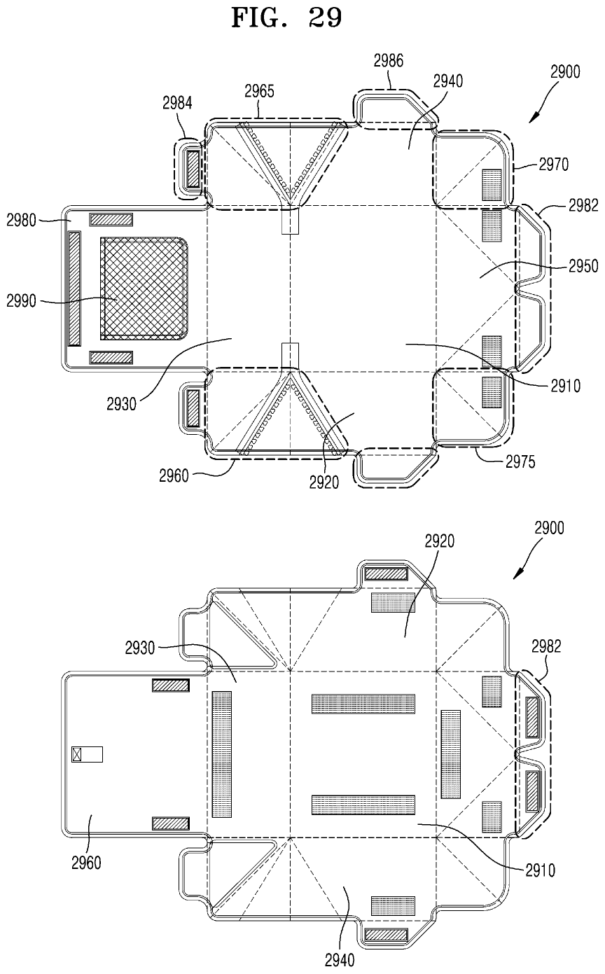

FIG. 29 is a view showing an example of a cold storage insert according to an embodiment of the present disclosure. FIG. 29 illustrates an inner surface and an outer surface of the cold storage insert in the development mode.

Referring to FIG. 29, a cold storage insert 2900 may include an insert bottom portion 2910, a plurality of insert side face portions 2920, 2930, 2940, and 2950, and a plurality of insert connection portions 2960, 2965, 2970, and 2975 connecting two adjacent insert side face portions to each other. The present embodiment may include an insert cover portion 2980, but the insert cover portion 2980 may be omitted according to an embodiment. In the following description, however, a case of including the insert cover portion 2980 is described. The cold storage insert 2900 may be implemented by various materials capable of maintaining cooling characteristics.

The insert side face portions 2920, 2930, 2940, and 2950 may be configured as first to fourth cooling side face portions respectively extending from the insert bottom portion 2910. The insert connection portions 2960 and 2965 between each of the first and third insert side face portions 2920 and 2940 and the second insert side face portion 2930 may be implemented as zippers as in the second connection structure of the foldable box 100 of the first embodiment of FIG. 1, and the insert connection portions 2970 and 2975 between each of the first and third insert side face portions 2920 and 2940 and the fourth insert side face portion 2950 may be implemented as the edge areas as in the first connection structure of the foldable box 100 of the first embodiment.

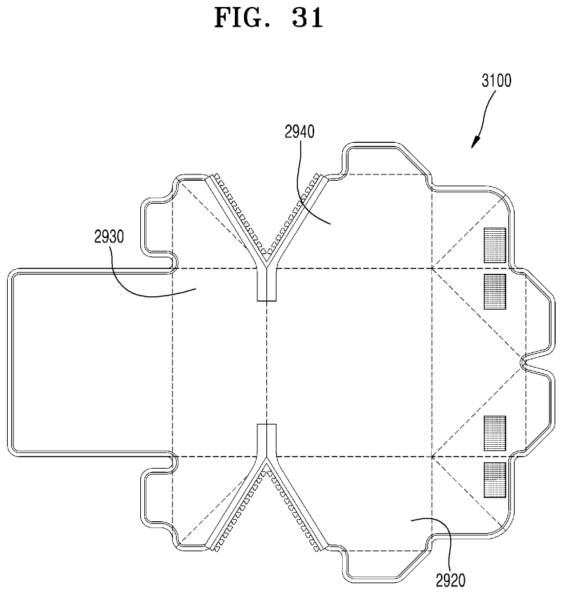

In addition, the insert connection portions may be implemented as the configurations of various connection portions used in the foldable boxes of the first to seventh embodiments, and various modified examples thereof are illustrated in FIGS. 31 to 34.

In the development mode, the insert bottom portion 2910, the insert side face portions 2920, 2930, 2940, and 2950, the insert connection portions 2960, 2965, 2970, and 2975 of the cold storage insert 2900 are all developed on the same plane. The cold storage insert 2900 may be deformed from the development mode to the box mode by connecting the insert side face portions 2920, 2930, 2940, and 2950 to one another through the insert connection portions 2960, 2965, 2970, and 2975. In an embodiment, in order to prevent generation of heat loss between the respective insert side face portions 2920, 2930, 2940, and 2950 of the cold storage insert 2900 in the box mode, the connection portions that connect between the insert side face portions 2920, 2930, 2940, and 2950 may each be implemented in a shape of connecting the two adjacent side face portions.

In another embodiment, the cold storage insert 2900 may include cooling collection fold lines corresponding to the collection fold lines of the foldable box. The cold storage insert 2900 may be deformed from the box mode to the collection mode by folding along the cooling collection fold lines. In the present embodiment, the cooling collection fold lines may be formed by zipper lines connecting each of the first and third side face portions 2920 and 2940 and the second side face portion 2930 to each other.

The insert cover portion 2980 may be connected to the second side face portion 2930. To fix the insert cover portion 2980, the cold storage insert 2900 may include the first flap portion 2982 in a wing shape at the upper edge of the fourth side face portion 2950 and the second flap portion 2984 and the third flap portion 2986 each in a wing shape at the upper and side edges of each of the first and third side face portions 2920 and 2940.

A fastening device such as Velcro and the like exists at one side of the insert cover portion 2980, a fastening device such as Velcro and the like exists in the first flap portion 2982, the second flap portion 2984, the third flap portion 2986, and the insert cover portion 2980 may be connected and fixed to the first flap portion 2982, the second flap portion 2984, and the third flap portion 2986.

The cold storage insert 2900 may further include a coolant accommodation portion 2990 for accommodating a coolant at one surface of the insert cover portion 2980. The coolant accommodation portion 2990 may be implemented as a net-shaped pouch. For example, an ice pack and the like may be used as the coolant.

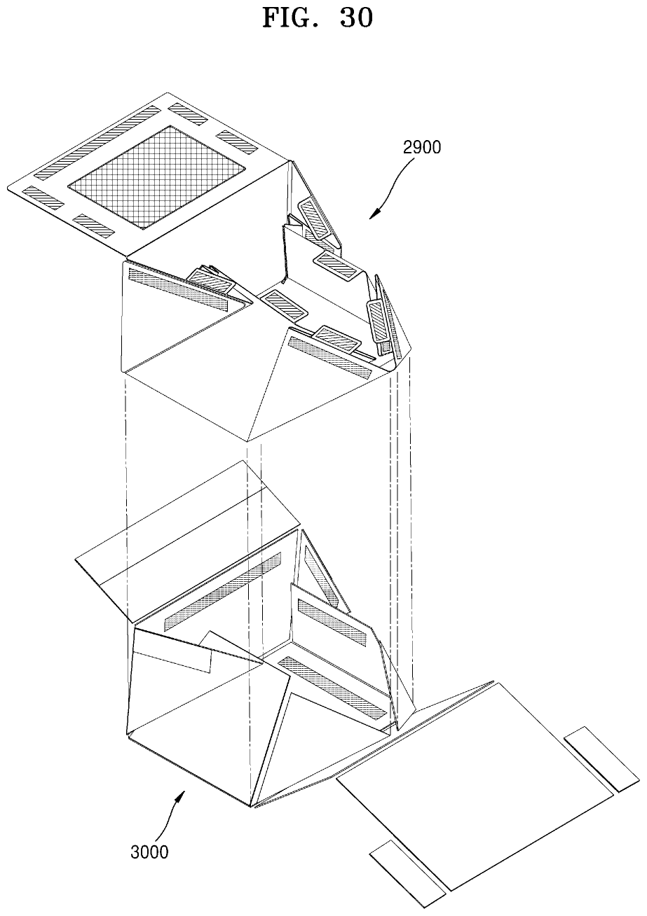

FIG. 30 is a view showing an example of a combination of a foldable box and a cold storage insert, according to an embodiment of the present disclosure.

Referring to FIG. 30, the cold storage insert 2900 may be detached from and attached to the inside of a foldable box 3000. In another embodiment, when cooling collection fold lines corresponding to the collection fold lines of the foldable box 3000 exist in the cold storage insert 2900, the foldable box 3000 may be deformed, with the cold storage insert 2900, to the collection mode described above. The foldable box 3000 may be any one of the foldable boxes of the first embodiment to seventh embodiments described above.

FIGS. 31 to 34 are views showing various modified examples of the cold storage insert according to an embodiment of the present disclosure.

Referring to FIG. 31, in a cold storage insert 3100, insert connection portions between first and third insert side face portions 2920 and 2930 and the second insert side face portion 2930 may be implemented by zippers. While the cold storage insert 2900 of FIG. 29 has a structure in which the portions between each of the first and third insert side face portions 2920 and 2940 and the second insert side face portion 2930 are connected, the cold storage insert 3100 of the present embodiment has a structure in which empty space exists as the portions between each of the first and third insert side face portions 2920 and 2930 and the second insert side face portion 2930 are cut.

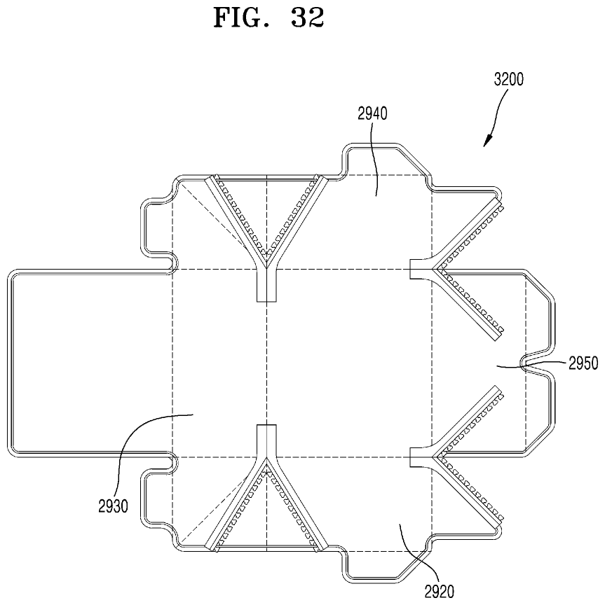

Referring to FIG. 32, in a cold storage insert 3200, the insert connection portions between the first and third insert side face portions 2920 and 2940 and the second insert side face portion 2930 are implemented in the same shape as that of FIG. 29, and the insert connection portions between the first and third insert side face portions 2920 and 2940 and the fourth insert side face portion 2950 are configured as the insert connection portions connected to the fourth side face portion in a diagonal direction as in the foldable box 600 of the second embodiment (FIGS. 6 to 8).

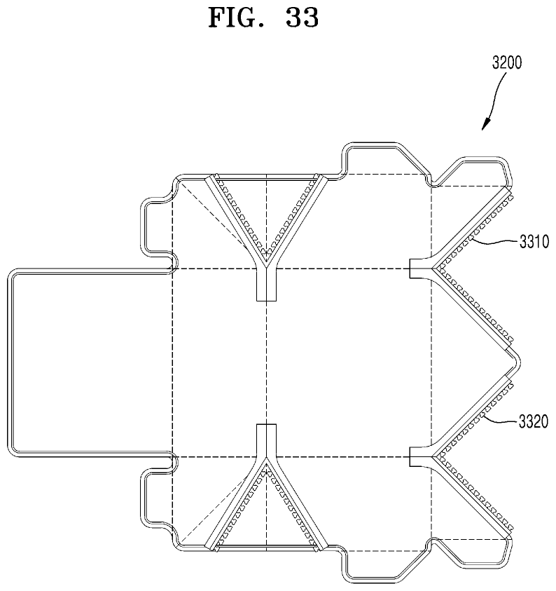

Referring to FIG. 33, a cold storage insert 3300 is implemented in a shape in which the areas of the first line and the second line of zippers 3310 and 3320 are removed from the cold storage insert 3200 of FIG. 32.

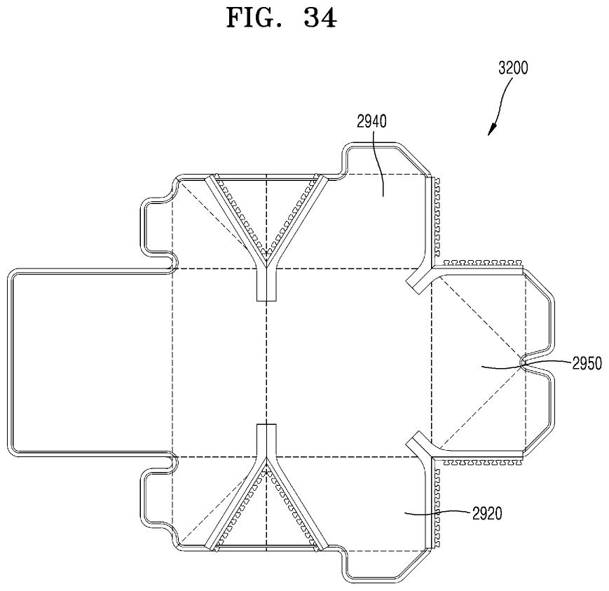

Referring to FIG. 34, in a cold storage insert 3400, the insert connection portions between the first and third insert side face portions 2920 and 2930 and the fourth insert side face portion 2950 in the cold storage insert 2900 of FIG. 29 are implemented by zippers located at the edges of two adjacent insert side face portions.

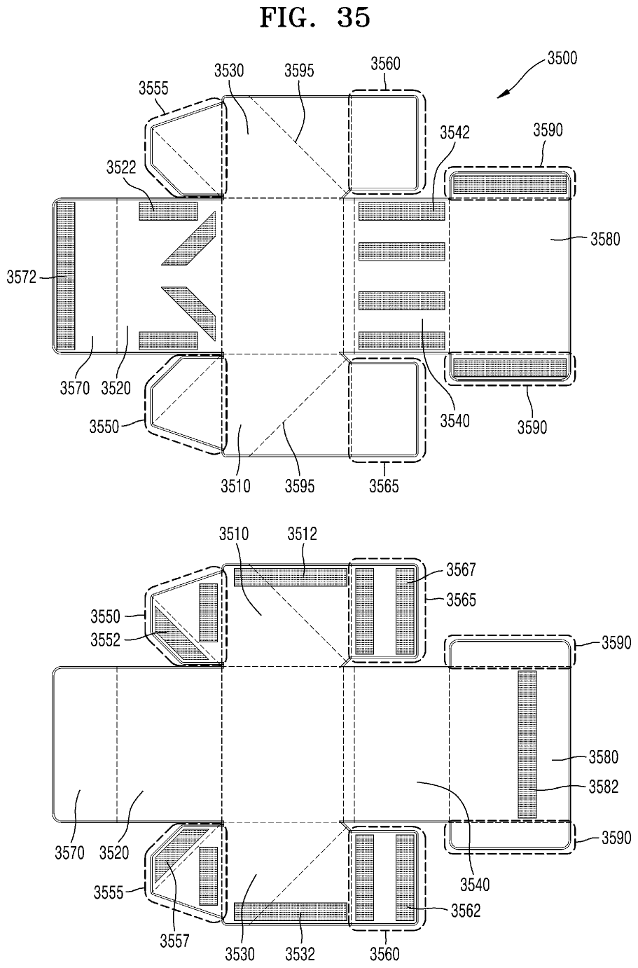

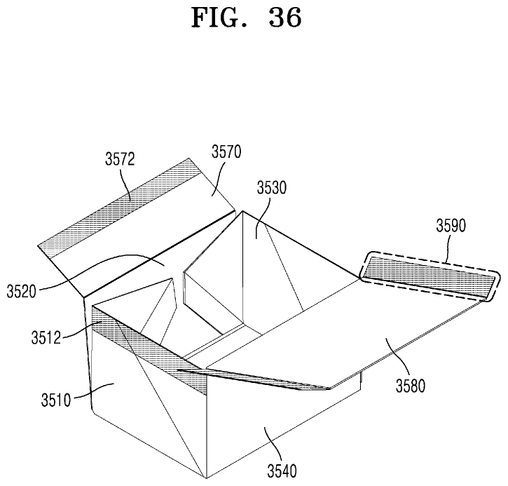

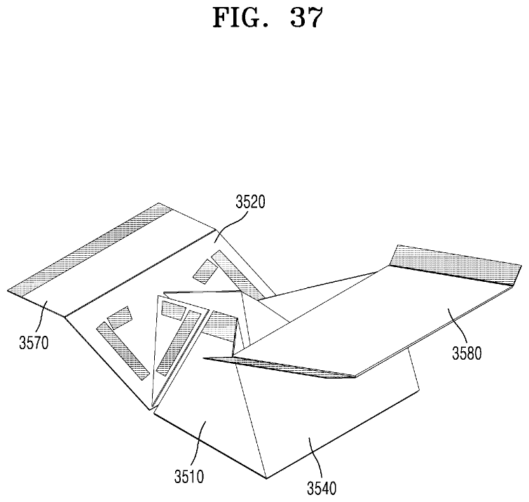

FIGS. 35 to 37 are views showing an example of a foldable box according to an eighth embodiment of the present disclosure. FIG. 35 illustrates an inner surface (upper diagram) and an outer surface (lower diagram) of a foldable box in the development mode, FIG. 36 illustrates the foldable box in the box mode, and FIG. 37 illustrates a process of deforming the foldable box in the collection mode.

Referring to FIGS. 35 to 37 together, in a foldable box 3500 according to an eighth embodiment, first to fourth side face portions 3510, 3520, 3530, and 3540 are all formed in a quadrangle shape, and the first to fourth connection portions 3550, 3555, 3560, and 3565, each connecting two adjacent side face portions, are formed as joint portions extending from both edges of each of the first and third side face portions 3510 and 3530. Although the present embodiment shows an example in which the respective joint portions of the first to fourth connection portions 3550, 3555, 3560, and 3565 extend from the side edges of each of the first and third side face portions 3510 and 3530, the respective joint portions of the first to fourth connection portions 3550, 3555, 3560, and 3565 may be variously modified to be, for example, formed at any one side of each of the first to fourth side face portions 3510, 3520, 3530, and 3540. For example, the joint portion of the first connection portion 3550 may be formed at the side edge of the second side face portion 3520.

Fastening devices 3522, 3534, 3552, 3557, 3562, and 3567 (e.g., Velcro, a snap button, a magnet, etc.) that may be connected and fixed to each other when the foldable box 3500 is deformed in the box mode exist in the joint portions between the first to fourth side face portions 3510, 3520, 3530, and 3540 and the first to fourth connection portions 3550, 3555, 3560, and 3565. For example, the fastening devices 3522, 3552, and 3557 exist at positions facing each other when the foldable box 3500 is deformed in the box mode, in the inner surface of the second side face portion 3520 and the outer surface of each of the joint portions of the first and second connection portions 3550 and 3555. Furthermore, fastening devices 3542, 3562, and 3567 exist at positions facing each other when the foldable box 3500 is deformed in the box mode, in the inner surface of the fourth side face portion 3540 and the outer surface of each of the joint portions of the third and fourth connection portions 3560 and 3565.

A flap portion 3590 exists at the side edge of the second cover portion 3580 extending from the fourth side face portion 3540. When the second cover portion 3580 covers the top surface of the foldable box 3500, the flap portion 3590 is connected to fastening devices 3512 and 3532 located at one sides of the first and third side face portions 3510 and 3530. After the second cover portion 3580 covers the top surface, the first cover portion 3570 is folded onto the second cover portion 3580 to be connected thereto. Fastening devices 3582 and 3572 that are connected to each other exist at one side of the inner surface of the second cover portion 3580 and one side of the outer surface of the first cover portion 3570.

Collection fold lines 3595 exist at positions corresponding to each other in the first and third side face portions 3510 and 3530. As illustrated in FIG. 37, in the box mode, by pulling the second side face portion 3520, the connection of the connection portions 3550 and 3555 between the second side face portion 3520 and the first and third side face portions 3510 and 3530 is released, and by folding the first and third side face portions 3510 and 3530 along the collection fold line 3595, the foldable box 3500 may be deformed in the collection mode.

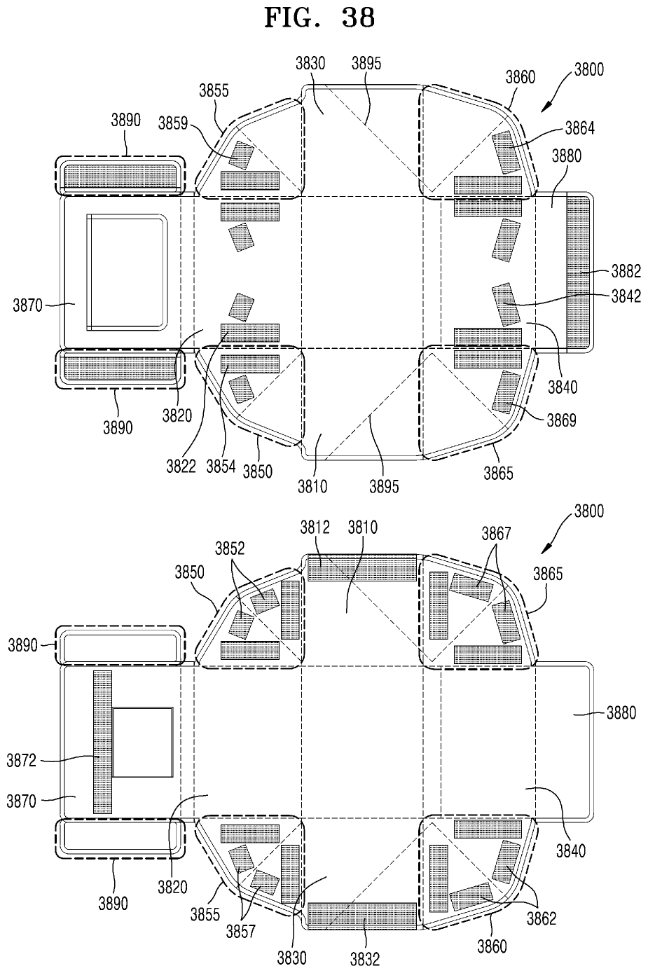

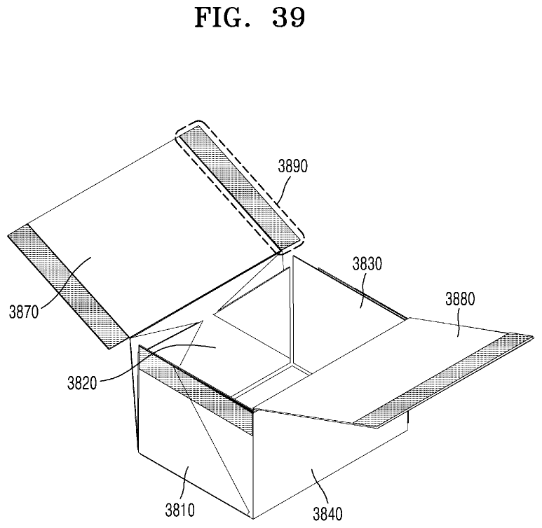

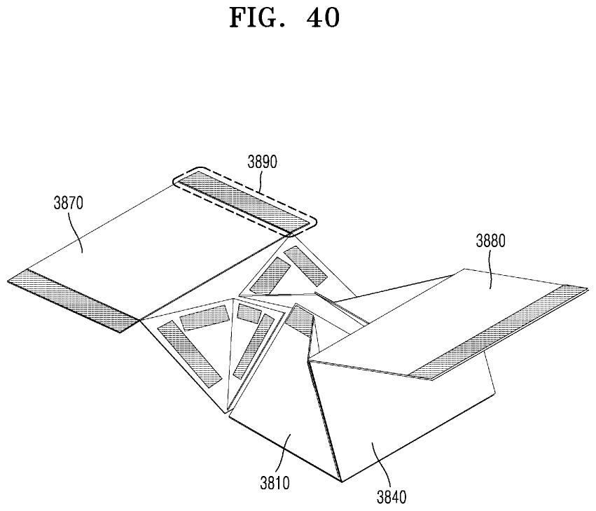

FIGS. 38 to 40 are views showing an example of a foldable box according to a ninth embodiment of the present disclosure. FIG. 38 illustrates an inner surface (upper diagram) and an outer surface (lower diagram) of a foldable box in the development mode, FIG. 39 illustrates the foldable box in the box mode, and FIG. 40 illustrates a process of deforming the foldable box in the collection mode.

Referring to FIGS. 38 to 40 together, in a foldable box 3800 according to a ninth embodiment, first to fourth side face portions 3810, 3820, 3830, and 3840 are all formed in a quadrangle shape, and first to fourth connection portion 3850, 3855, 3860, and 3865 are all connected to the edges of two adjacent side face portions in the development mode and formed as edge areas that are folded to face each other when the foldable box 3800 is folded in the box mode, as in the first connection structure of the first embodiment.

As the portions between the two adjacent side face portions are all provided with the first to fourth connection portions 3850, 3855, 3860, and 3865 of the edge areas, the bottom portion and the first to fourth side face portions 3810, 3820, 3830, and 3840 of the foldable box 3800 are all formed in one polygonal shape in which no cut portion exists on the same plane. The edge areas may include fastening devices 3852, 3857, 3862, and 3867 so that the two faces folded in a wing shape to face each other when the foldable box 3800 is folded in the box mode are in close contact with each other. Furthermore, for the edge areas folded in a wing shape to be in close contact with the side face portions, fastening devices 3822, 3842, 3854, 3859, 3864, and 3869 exist in one side of each of the side face portions and the edge areas.

A first cover portion 3870 and a second cover portion 3880 are formed by respectively extending from the second side face portion 3820 and the fourth side face portion 3840. Flap portions 3890 exist at the sides of the first cover portion 3870. When the first cover portion 3870 covers a top surface of the foldable box 3800, the flap portions 3890 are connected and fixed to fastening devices 3812 and 3832 formed at one side of each of the first and third side face portions 3810 and 3830. The second cover portion 3880 is folded over the first cover portion 3870 and thus coupled thereto. Fastening devices 3872 and 3883 for mutual combination exist in one side of the inner surface of the first cover portion 3870 and the outer surface of the second cover portion 3880.

Collection fold lines 3895 exist at corresponding positions in the first and third side face portions 3810 and 3580. As illustrated in FIG. 40, the foldable box 3800 may be deformed in the collection mode by pulling the second side face portion 3820 in the box mode to release the connection of the connection portions 3850 and 3855 between the second side face portion 3820 and the first and third side face portions 3810 and 3830, and folding the first and third side face portions 3810 and 3830 along the collection fold lines 3895.

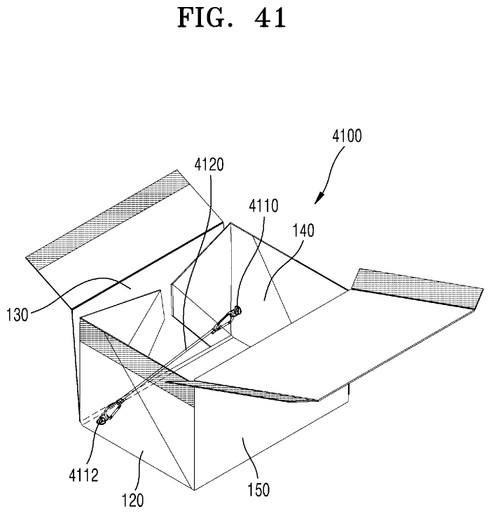

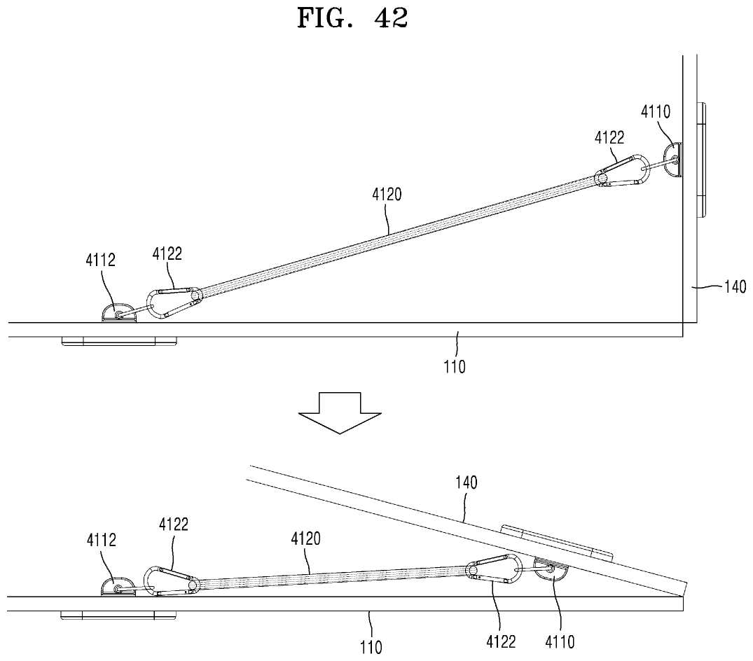

FIGS. 41 and 42 are views showing an example of a foldable box according to a tenth embodiment of the present disclosure.

Referring to FIGS. 41 and 42, a bottom portion and side face portions of a foldable box 4100 may be the same as those of any one of the first to ninth embodiments. The present embodiment is described, for convenience of explanation, based on an assumption that the bottom portion and the side face portions are the same as those of the first embodiment.

The foldable box 4100 according to the tenth embodiment may include fixing devices 4110 and 4112 that are capable of attaching and detaching a string 4120 having a tension, such as a rubber string, a spring, and the like, to and from the third side face portion 140 and the bottom portion 110. Although the present embodiment shows a rubber string as an example of the string 4120 having a tension, this is merely an example, and various strings formed of a material having a tension may be applied to the present embodiment. However, for convenience of explanation, the following description is described based on an assumption of a rubber string.

A connection ring 4122 such as a hook and the like to be attachable to and detachable from the fixing device located at the bottom portion and the side face portion of the foldable box 4100 is provided at either side of the rubber string 4120. When the foldable box 4100 is folded in the box mode, as the portions between the respective side face portions 120, 130, 140, and 150 are connected and fixed by the connection portions, the third side face portion 140 may be prevented from being folded by the tension of the rubber string 4120 in an inward direction of the foldable box 4100. For example, after folding the foldable box 4100 in the box mode, a user may connect the rubber string 4120 to the fixing devices 4110 and 4112 inside the foldable box 4100.

When the connection of the connection portions between the second side face portion 130 and the first and third side face portions 120 and 140 is released, the third side face portion 140 is pulled by the tension of the rubber string 4120 in an inward direction of the foldable box 4100. In other words, when the connection of the connection portions between the second side face portion 130 and the first and third side face portions 120 and 140 is released, the deformation from the box mode to the collection mode may be automatically obtained.

When the foldable box 4100 is deformed from the box mode or the collection mode to the development mode, the rubber string 4120 is separated from at least one of the two fixing devices 4110 and 4112. When cleaning is needed, the rubber string 4120 may be removed from the foldable box 4100, and when the cleaning is completed, the rubber string 4120 may be connected to any one of the fixing devices 4110 and 4112 and the foldable box 4100 is folded in the collection mode for storage.

In the present embodiment, to help understanding, an example of the connection of the rubber string 4120 between the third side face portion 140 and the bottom portion 110 is illustrated, but in another embodiment, a configuration of a rubber string connection between the first side face portion 120 and the bottom portion 110 may be added. In another embodiment, the fixing devices 4110 and 4112 to which a rubber string is connected may be respectively located at the first side face portion 120 and the third side face portion 130.

While this disclosure has been particularly shown and described with reference to preferred embodiments thereof, it will be understood by those of ordinary skill in the art that various changes in form and details may be made therein without departing from the spirit and scope of the disclosure as defined by the appended claims. The preferred embodiments should be considered in descriptive sense only and not for purposes of limitation. Therefore, the scope of the disclosure is defined not by the detailed description of the disclosure but by the appended claims, and all differences within the scope will be construed as being included in the disclosure.

1. A foldable box capable of being deformed in a box mode, a development mode, and a collection mode, the foldable box comprising:
a bottom portion;
a plurality of side face portions connected to the bottom portion; and
a plurality of connection portions connecting two adjacent side face portions to each other in the box mode,
wherein in the development mode, the plurality of side face portions are developed in an outward direction and located on a same plane as the bottom portion, at least one collection fold line in a diagonal direction exists on each face of first and third side face portions facing each other of the plurality of side face portions, and
the foldable box is deformed from the box mode to the collection mode by folding the first and third side face portions along the collection fold line in an inward direction of the foldable box to be folded over the bottom portion.

2. The foldable box of claim 1, wherein the collection fold line of each face of the first and third side face portion is formed as a straight line in a diagonal direction inclined at a certain angle and connected to a vertex of the bottom portion to allow two areas divided by the collection fold line to be folded to face each other along the collection fold line.

3. The foldable box of claim 1, wherein deformation from the box mode to the collection mode is obtained in a state in which a connection of the connection portions between at least one of the second and fourth side face portions and the first and third side face portions is maintained.

4. The foldable box of claim 1, wherein the plurality of connection portions comprise a fastening device including at least one of a zipper, Velcro, a snap button, and a magnet that connects edges of two adjacent side face portions to each other.

5. The foldable box of claim 1, wherein each of the plurality of connection portions comprises an edge area connected to each of edges of adjacent two side face portions when the plurality of side face portions and the bottom portion are developed on a same plane, and folded to face each other in an inward or outward direction of the foldable box when the foldable box is folded.

6. The foldable box of claim 5, wherein fastening devices exist in two areas of the edge area facing each other to closely contact each other when the foldable box is folded.

7. The foldable box of claim 1, wherein the plurality of connection portions comprise:
a first connection portion located between the second side face portion and the first and third side face portions adjacent thereto and including an edge area connected to each of edges of adjacent two side face portions when the foldable box is developed on a same plane, and folded to face each other when the foldable box is folded; and
a second connection portion connecting the fourth side face portion and the first and third side face portions adjacent thereto to each other using a fastening device including at least one of a zipper, Velcro, a snap button, and a magnet.

8. The foldable box of claim 1, wherein at least two connection portions of the plurality of connection portions include a fastening device connecting to the second or fourth side face portion along the diagonal direction on each of the first and third side face portions, and the fastening device is used as the collection fold line.

9. The foldable box of claim 1, wherein the first and third side face portions each have a trapezoidal shape, and
a joint portion extending from a side of the second or fourth side face portion is connected to the first and third side face portions, the first and third side face portion and the joint portion forming side faces of the foldable box.

10. The foldable box of claim 1, further comprising a cold storage insert including an insert bottom portion and an insert side face portions developed on a same plane, wherein the insert bottom portion and the insert side face portion are folded and inserted into the foldable box.

11. The foldable box of claim 10, wherein the cold storage insert includes a cooling collection fold line corresponding to the collection fold line in the insert side face portion, and
the foldable box is deformed from the box mode to the collection mode while the cold storage insert is inserted in the foldable box.

12. The foldable box of claim 1, further comprising:
a cover portion;
a first flap portion protruding from a side of the cover portion to have a certain area; and
a second flap portion formed in a side of the side face portion in a certain area, wherein, when the cover portion covers a top surface of the foldable box, the first flap portion is connected to a side surface of the foldable box and the second flap portion surrounds and connects to the cover portion.

13. The foldable box of claim 1, further comprising a string having a tension and connected between the bottom portion and at least one side face portion of the second and fourth side face portions.
